(19) United States
(12) Patent Application Publication
(10) Pub. No.: US 2011/0112985 A1
(43) Pub. Date: May 12, 2011

(54) METHOD AND SYSTEM FOR GENERATING A FINANCIAL PLAN SCORE

(76) Inventor: Peter George KOCMOND, Milton, GA (US)

(21) Appl. No.: 12/940,188

(22) Filed: Nov. 5, 2010

Related U.S. Application Data
(60) Provisional application No. 61/280,518, filed on Nov. 6, 2009.

(51) Int. Cl. G06Q 40/00

(52) U.S. Cl. 705/36 R

(57) ABSTRACT

A system for generating a financial plan score including a financial plan engine operable within a service provider computing system. The financial plan engine generates a financial plan score by interpreting information input by a user. The system includes at least one user device in network communication with the financial plan engine. A user inputs information into the financial plan engine through the at least one user device. And, the system includes at least one third-party data source. The financial plan engine is in network communication with the at least one third-party data source and is operable to produce a financial score.

### CROSS-REFERENCE TO RELATED APPLICATION

This application claims the benefit of U.S. Provisional Patent Application Ser. No. 61/280,518, filed Nov. 6, 2009, the entirety of which is hereby incorporated herein by reference for all purposes.

### FIELD OF THE INVENTION

The invention relates generally to providing financial planning guidance, and more specifically to systems and methods for generating a quality score of financial plans.

### BACKGROUND OF THE INVENTION

Conventional financial planning involves calculating and demonstrating financial success based on an individual's ability to achieve a certain likelihood of reaching a specific goal based on various inputs and forecasting methods. This is accomplished by obtaining various inputs from the individual and executing a forecasting analysis to determine an optimized asset allocation of investments required to achieve a reasonable likelihood of reaching the individual's stated goals. However, this conventional financial planning's view of success is flawed because the factors involved in the forecasting process are highly unpredictable. Also, the focus of such methods is placed on an individual's ability to meet a specific goal, without taking into account the entire financial needs, other competing goals, and life-phase situation of the individual.

Existing financial planning software does offer a system or framework for providing the user access to many financial planning practices and components. However this conventional software has the same shortcomings and focuses on an individual's ability to reach a specific goal based on the output of a forecasting method and a recommended asset allocation model. Thus it does not helping the individual balance competing needs and goals in order to enable consistent guidance across a comprehensive financial plan.

In some situations, individuals seek the services of an investment professional to assist them with their financial needs. Investment professionals assist individuals with investing or product guidance in support of a specific need or goal and can create a financial plan. However, this process is non-repeatable and unique to each investment professional. Also, these services are typically only available to high net worth individuals. Additionally, investment professionals are geared towards product sales and asset gathering techniques, not independent and comprehensive financial guidance.

Therefore, a need exists for improved systems and methods for providing guidance for comprehensive financial planning. It is to the provision of such solutions that the present invention is primarily directed.

### SUMMARY

Embodiments of the present invention provide a method and system for generating a financial plan score. The systems include, and the methods are used in connection with, a computing system specialized for the particular functionality described for each embodiment.

An exemplary embodiment includes a system for generating a financial plan score including a financial plan engine operable within a service provider computing system. The financial plan engine generates a financial plan score by interpreting information input by a user. The system includes at least one user device in network communication with the financial plan engine. A user inputs information into the financial plan engine through the at least one user device. And, the system includes at least one third-party data source. The financial plan engine is in network communication with the at least one third-party data source.

Another exemplary embodiment includes a method for generating a financial plan score. The method includes entering user information into a financial plan engine through a network communication. This user information includes at least one of personal information, personal financial information, and financial goals. The method also includes accessing at least one third-party data source via the network communication. This third-party data source is accessed by information input by the user. The method further includes generating a user profile comprising the entered user information and the accessed third-party data source information and prioritizing user goal information through pre-determined responses generated by the financial plan engine. And, the method includes assigning a numerical value to each financial goal by comparing the user information with the prioritized status of the goals. In this step each numerical value is assigned to each user financial goal based on priority, and the aggregate of the goal numerical value represents the maximum amount attainable. The method further includes generating an overall score, with the score representing a comparison of the user financial goals and the user profile.

A further exemplary embodiment includes another method for generating a financial score. This method includes accessing a user profile. This user profile includes at least information including family status, financial status and financial goals. This method also includes generating at least one recommendation based on the user profile and prioritizing the financial goals. These financial goals are prioritized by evaluating user-entered preferences comprising at least goal categorization and goal weight. And, this method further includes scoring the financial goals with a numeric value up to a maximum value. Each score is calculated by comparing the difference between the at least one recommendation and the prioritized financial goals.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are explanatory of example embodiments of the invention, and are not restrictive of the invention, as claimed.

### BRIEF DESCRIPTION OF THE DRAWINGS

Reference will now be made to the accompanying drawings, which are not necessarily drawn to scale, and wherein:

FIG. 1 is a schematic diagram of a system for providing financial planning guidance, according to an example embodiment of the invention.

FIG. 2 is a block diagram of example components of a financial plan engine, according to an illustrative embodiment of the invention for use with the system of FIG. 1.

FIG. 3 is a schematic flow chart of a method for providing financial planning guidance, according to an example embodiment of the invention.

FIG. 4 is a flow chart illustrating example components of the method shown in FIG. 3, showing an example method for generating or creating a user profile.

FIG. 5 is a flow chart illustrating example components of the method shown in FIG. 3, showing an example method for identifying or creating goals.

FIG. 6 is a flow chart illustrating example components of the method shown in FIG. 3, showing an example method for customizing goals.

FIG. 7 is a flow chart illustrating example components of the method shown in FIG. 3, showing an example method for adding accounts the user's financial plan.

FIG. 8 is a flow chart illustrating example components of the method shown in FIG. 3, showing an example method for creating updated goal recommendations.

FIG. 9 is a flow chart illustrating example components of the method shown in FIG. 3, showing an example method for creating goal categorizations.

FIG. 10 is a flow chart illustrating example components of the method shown in FIG. 3, showing an example method for creating a goal weighting.

FIG. 11 is a flow chart illustrating example components of the method shown in FIG. 3, showing an example method for creating a goal element score and illustration for each goal element.

FIG. 12 is a flow chart illustrating example components of the method shown in FIG. 3, showing an example method for creating a goal score and illustration for each goal.

FIG. 13 is a flow chart illustrating example components of the method shown in FIG. 3, showing an example method for creating an overall plan score and illustration.

FIG. 14 is a flow chart illustrating example components of the method shown in FIG. 3, showing an example method for providing plan maintenance.

### DETAILED DESCRIPTION OF THE INVENTION

Reference now will be made in detail to example embodiments of the invention. It will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the procedures are well known and commonly employed in the art. Conventional methods are used for these procedures, such as those provided in the art and various general references. Where a term is provided in the singular, the inventor also contemplates the plural of that term. The nomenclature used herein and the devices and procedures described below are those well known and commonly employed in the art. All patents listed herein are expressly incorporated by reference in their entirety.

Disclosed are systems and methods for providing financial planning guidance. Information associated with a user or consumer, including identity information and/or financial information associated with the user, can be provided to, and received by, a financial plan engine. At least a portion of the received information can be utilized in the generation or construction of financial goals for the user. In certain embodiments, initial financial goals can be provided to the user, and the initial financial goals can be edited or customized by the user and/or supplemented with additional user-defined goals. Additionally, as desired, the financial goals can be updated based upon the receipt of additional information by the financial plan engine, for example information associated with financial accounts of the user. The financial goals and/or elements or components of the financial goals can be categorized and weighted. The weighted goals and/or elements can then be ranked or scored in order to generate an indication for obtaining the goal. In example embodiments, an overall financial plan score can then be generated, and the overall financial plan score can be provided to the user. As desired, the financial plan and/or components of the financial plan can be periodically updated and/or revised based at least in part upon the receipt of additional information by the financial plan engine.

Illustrative embodiments of the invention now will be described more fully hereinafter with reference to the accompanying drawings, in which some, but not all embodiments of the invention are shown. Indeed, the invention can be embodied in many different forms and should not be construed as limited to the embodiments set forth herein; rather, these embodiments are provided so that this disclosure will satisfy applicable legal requirements.

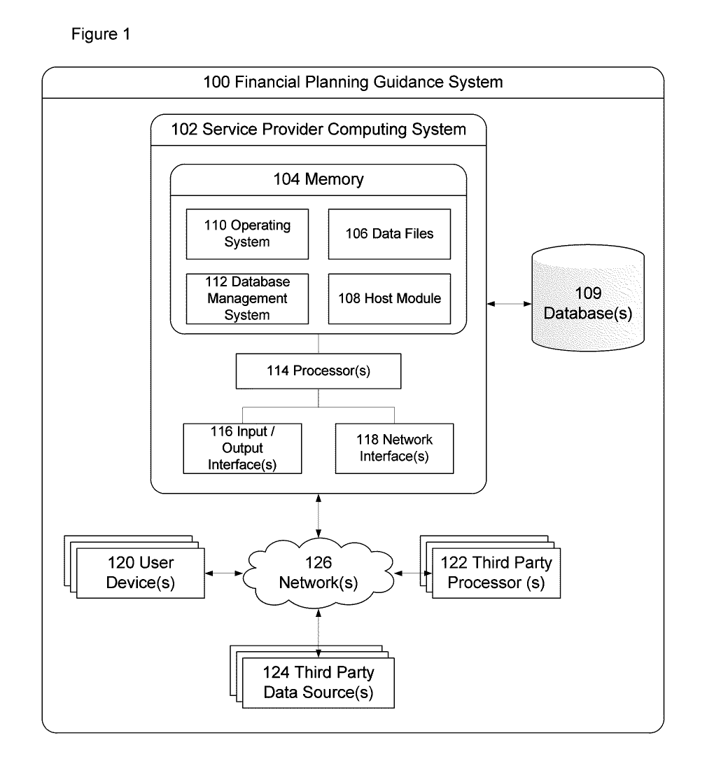

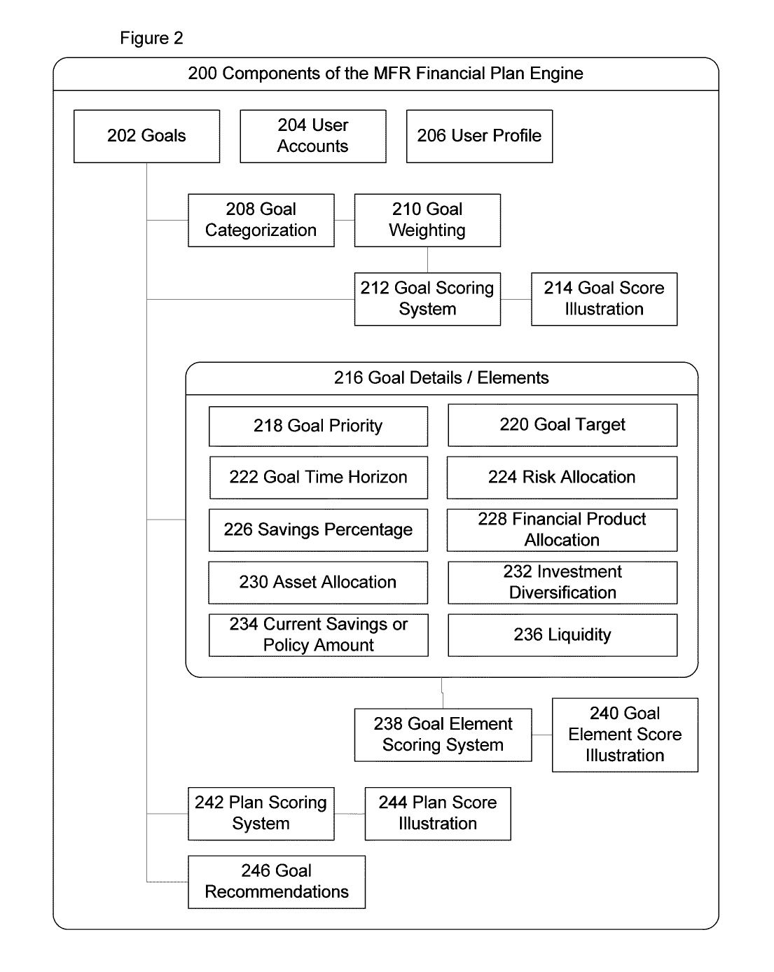

An example system 100 for providing financial planning guidance will now be described with respect to FIGS. 1 and 2. As shown in FIG. 1, the system 100 can include a service provider computing system 102, one or more user devices 120, one or more third party data sources 124, and/or one or more third party data processors 122, all as described in more detail below. One or more of the components of the system 100 can include one or more processing devices that can be configured for accessing and reading associated computer-readable media having stored thereon data and/or computer-executable instructions for implementing the various methods of the invention.

Typically, network devices and systems, including one or more of the service provider computing systems 102, user devices 120, third party data sources 124, and third party data processors 122, can include, or otherwise be associated with, suitable hardware and/or software for transmitting and receiving data and/or computer-executable instructions over one or more communications links or networks 126. These network-connected devices and systems 102,120,122,124 can also include a predetermined number of processors for processing data and executing computer-executable instructions, as well as other internal and peripheral components. Further, these network devices and systems can include or be in communication with a predetermined number of suitable memory devices 109 operable to store data and/or computer-executable instructions. By executing computer-executable instructions, each of the network devices can form a special purpose computer or particular machine. As used herein, the term “computer-readable medium” describes any suitable non-transitory memory or memory device.

The service provider computing system 102 can be associated with a service provider or financial planning entity that provides financial planning guidance and/or financial planning strategies to customers or users. For purposes of this disclosure, the service provider computing system 102 is generally referred to as a service provider. The service provider 102 can be any suitable processor-driven device that facilitates the generation of financial planning guidance and the provision of at least a portion of the generated financial planning guidance to an appropriate user device. For example, the service provider 102 can be a computing device that includes server computers, mainframe computers, networked computers, desktop computers, personal computers, digital assistants, personal digital assistants, digital tablets, Internet appliances, application specific circuits, microcontrollers, minicomputers, and/or any other processor-based device(s). The execution of the computer-implemented instructions by the service provider 102 can form a special purpose computer or other particular machine that facilitates the financial planning guidance to a user. Additionally, in certain embodiments of the invention, the operations and/or control of the service provider 102 can be distributed amongst several processing components.

In addition to one or more processor(s) 114, the service provider 102 can include one or more memory devices 104, one or more input/output (“I/O”) interfaces 116, and one or more network interfaces 118. The one or more memory devices 104 can be any suitable memory devices for example, caches, read only memory devices, random access memory devices, magnetic storage devices, etc. The one or more memory devices 104 can store data, executable instructions, and/or various program modules utilized by the service provider, for example, data files 106, an operating system (OS) 110, a database management system (DBMS) 112, and/or a financial plan engine (shown in FIG. 2) and/or host module 108. The data files 106 include a wide variety of different data in various embodiments, for example, user or customer profiles, financial information associated with various users, stored data associated with one or more third party data sources and/or stored data associated with various third party processors.

The operating system (OS) 110 is a suitable software module that controls the service provider 102. The OS 110 can also facilitate the execution of other software modules by the one or more processors 114, for example, the financial plan engine (shown in FIG. 2). The OS 110 can be, but is not limited to, Microsoft Windows®, Apple OSX™, Linux™, Unix™, or a mainframe operating system. The database management system (“DBMS”) 112 can facilitate the maintenance of information stored in one or more databases 109 associated with the service provider 102. The host module 108 can facilitate the receipt and/or processing of requests and/or other information that is received from a user via a suitable user device 120. For example, the host module 108 can include a web server or other dedicated program that is operable to receive requests and/or information from client modules, for example web browsers, associated with various user devices.

The financial plan engine 200 (shown in FIG. 2), which can be stored in memory 104 as described above, can calculate and illustrate an individual's financial success based on how the individual prioritizes, funds, and manages all aspects of their current financial situation. This system 100 can evaluate and provide feedback based on identification of all relevant goals, allocated reasonable savings rates, set realistic goal targets, and have properly managed their investments. The individual's overall financial plan can be evaluated and a success score and illustration can be presented to the user. The individual's underlying goals can also be individually evaluated and a success score and illustration can be presented to the user. As desired in various embodiments of the invention, the financial plan engine 200 can include any number of individual modules and/or components. In this regard, operations of the financial plan engine 200 can be distributed amongst several processing modules and/or processing devices. One example of the components of the financial plan engine is described below with reference to FIG. 2.

The one or more I/O interfaces 116 can facilitate communication between the service provider 102 and one or more input/output devices, for example, a universal serial bus port, a serial port, a disk drive, a CD-ROM drive, and/or one or more user interface devices, such as, a display, keyboard, keypad, mouse, control panel, touch screen display, microphone, etc. that facilitate user interaction with the service provider. The one or more I/O interfaces 116 can be utilized to receive or collect data and/or user instructions from a wide variety of input devices. Received data can be processed by the service provider 102 as desired in various embodiments of the system 100 and/or stored in the one or more memory devices 104.

The one or more network interfaces 118 can facilitate connection of the service provider 102 to one or more suitable networks 126, for example, a local area network, a wide area network, the Internet, a cellular network, a radio frequency network, a Bluetooth™ enabled network, a Wi-Fi™ enabled network, a satellite-based network, any wired network, any wireless network, etc. In this regard, the service provider 102 can communicate with other components of the system 100.

Additionally, as shown in FIG. 1, one or more database(s) 109 can be associated with the computing system 102 and/or a service provider. A wide variety of different types of data can be stored and/or organized in any number of databases 109 as desired in various embodiments of the system 100. For example, databases 109 can be utilized to store information associated with target customers, target businesses, interested customers or consumers, application processing and/or enrollment information, and/or various statistical information.

With continued reference to FIG. 1, the system 100 can include any number of user devices 120 or customer devices. Each of the user devices 120 can be associated with a user or customer of the service provider 102. It will be appreciated that any number of user devices 120 can be associated with an individual user. A user can utilize a suitable user device 120, such as a personal computer, personal digital assistant, mobile devices, etc., to access the service provider 102 in order to receive financial planning guidance and/or financial planning information. Each of the user devices 120 can be a suitable processor-driven device that facilitates communication with the service provider 102. Certain components of the user device 120 can be similar to the components of the service provider 102 illustrated in FIG. 1. For example, the user device 120 can include one or more processors, one or more memory devices, one or more I/O interfaces, and/or one or more network interfaces. The memory of the user device 120 can store data and/or software components that are utilized by the processors, for example, a client module (e.g., a web browser) that can facilitate communication with the host module 108 of the service provider 102 via the one or more networks 126.

With continued reference to FIG. 1, any number of third party data sources 124 and/or third party processors 122 can be provided. A third party data source 124 can be operable to provide data to one or more other components of the system 100. For example, the third party data source 124 can facilitate the provision of information to the service provider 102 for processing. Examples of third party data sources 124 include, but are not limited to, financial data providers, financial data providers, budgeting tools and software, and firms which provide REGISTERED INDEPENDENT ADVISORY services. Examples of financial data can include information related to annuity or securities (e.g., price or value, performance, expense detail, cost, manager tenure, investment philosophy, top holdings, and standard deviation). In order to assist users manage their income and cash flow, this system 100 can facilitate information sharing with budgeting software or proprietary budgeting service provider system. The system 100 can choose to integrate with REGISTERED INDEPENDENT ADVISORY firms in order to offer asset allocation and specific investment guidance. Similarly, the third party data processor 122 can facilitate the processing of data provided by one or more other components of the system 100, such as the service provider 102. Processed data can then be provided to the service provider 102 and/or to one or more other components for further processing. Examples of third party data processors 122 include, but are not limited to, MORNINGSTAR or LIPPER.

Each third party data source 124 and/or third party processor 122 can include or be associated with one or more computers or computing systems, such as one or more server computers. The computers can include one or more components similar to those of the service provider 102.

As desired, the system 100 can include more or less than the components illustrated in FIG. 1. The system 100 of FIG. 1 is provided by way of example only.

FIG. 2 is a block diagram of one example of the components of a financial plan engine 200 that can be utilized in accordance with various embodiments of the system (FIG. 1). As shown in FIG. 2, the financial plan engine 200 can include: a user profile 206 including requested information (e.g., income, age, children, zip code, marital or partner status, dependents, debt, mortgage information, spouse or partner information, and investment expectations); user existing accounts 204 (e.g., bank accounts, investment accounts, pension plan, insurance policies); user goals 202 (e.g., retirement, car purchase, home purchase, debt write-down, emergency fund, life insurance, disability insurance, mortgage write-down, long term care, college tuition); user goal categorization 208 (e.g., core goals, primary goals, secondary goals, not applicable, or fully funded); user goal weighting 210 (e.g., “core goals scores are multiplied by 2×,” “primary goal scores are multiplied by 1×,” and “secondary goal scores are multiplied by 0.5×”); user goal details/elements 216 (e.g., goal priority 218, goal target 220, savings percentage 226, goal time horizon 222, risk allocation 224, financial product allocation 228, asset allocation 230, investment diversification 232, current savings or policy amount 234 and liquidity 236), a scoring system (e.g., a numeric representation from 0 to 100 for the overall plan 242, individual goals 212, and individual goal details or elements 238), scoring illustrations (e.g., a green, yellow, red illustration or a vertical bar to depict the score of the overall plan 244, individual goal 214, and individual goal details or elements 240), and goal recommendations 246 (e.g., “consider adding an emergency fund to your goals,” “consider prioritizing retirement higher in your plan,” “consider adding $500 a month to your mortgage payments”).

As desired, various embodiments of the system can include a financial plan engine with different components than those illustrated in FIG. 2. Additionally, the components and/or modules illustrated in FIG. 2 can be executed by any number of computing systems as desired.

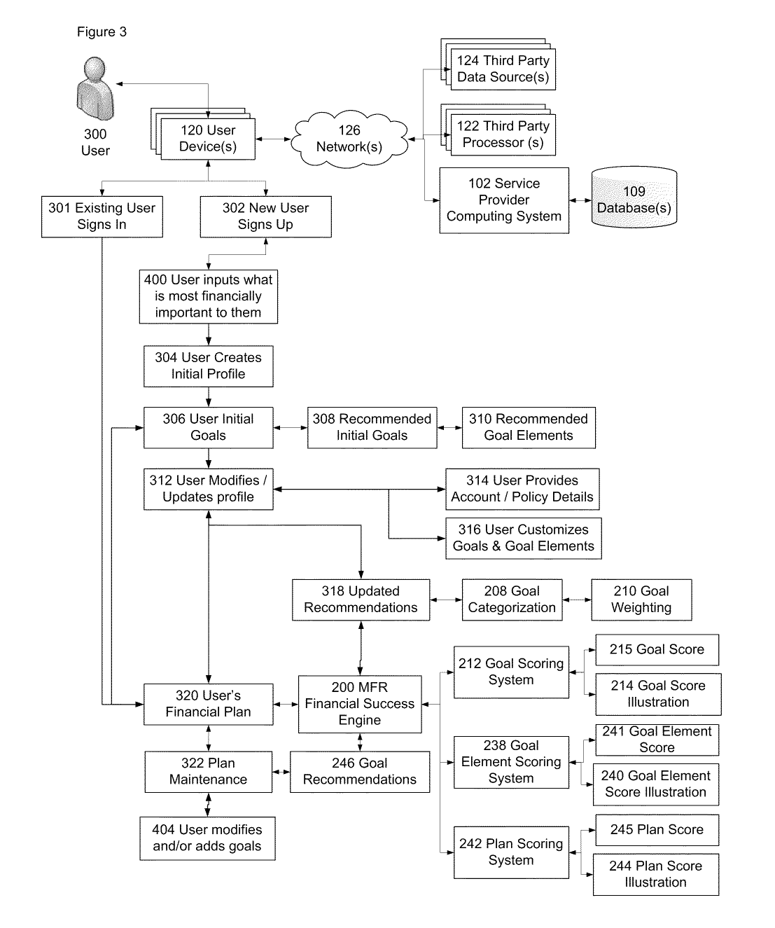

FIG. 3 is a flow chart of a method for providing financial planning guidance, according to another example embodiment of the system. The method can be performed by a suitable service provider, for example, the service provider illustrated in FIG. 1. The user 300 then enters its goals by entering a goal at 400. This can be done by creating an account at 302. The method can begin with a user 300 answering from a list of pre-determined responses (e.g., “I want to live debt free,” “I want to provide and protect my family,” “I want to save for college,” “I want to save for a home”) or entering a customized response (e.g., what financially is most important to them) and in what priority. Based on what the user 300 has indicated as most financially important to them at 400 the user 300 is prompted to answer additional questions in order to generate an initial profile at 304. Profiling questions can be both standardized and dynamic based on what is intended at 400 to be most financially important to the user. Example standardized questions can include: partner or martial status, age, dependent information, income, partner or spouse income, gender, and zip code. Example dynamic questions can include: for users who responded that they want to live debt free, what is financially important to them, what types of debt do they currently have (e.g., credit card, home mortgage, car, or other debt) and the outstanding balances for each form of debt they have. The user 300 can provide additional information via one or more suitable user devices 120. Example information includes contact information and/or financial information. And, the information can be utilized to construct and update the user profile at 304.

Based on the initial user profile, the service provider 102 can generate a set of recommended goals at 306 (e.g., emergency fund, life insurance, debt, disability insurance, home purchase, car purchase, and retirement) with recommended goal elements 310 (e.g., goal priority 218, goal target 220, goal time length/horizon 222, savings percentage 226, value of current savings 234, financial products allocation/utilization 228, risk allocation/utilization 224, investment/asset allocation 230 and investment diversification 232). An example goal recommendation can resemble the following: Based on the user initial profile, an emergency fund can be recommended 308 with the following goal elements 216:
Goal Priority 218: Example: 1 (the highest or most important goal)
Goal Target 220: Example: ½ of the user's 300 annual income (or 6 months of savings). If the user 300 is married or has a partner the goal target 220 can be reduced to ¼ of the user's 300 income (or 3 months of savings)
Goal Time Horizon 222: Example: 40 months (or 3 years and 4 months). Goal Time Horizon 222 is a product of the Goal Target 220 subtracted by Current Savings 234 and then divided by Goal Savings 226
Goal Savings Percentage 226: Example: 2.5% of user 300 income. Goal Savings Percentage 226 is a proprietary calculation based on a recommended percentage of the user 300 income and profile 306 which is then allocated across user goals based on goal categorization 208.
Current Savings or Policy Amount 234: Example: $2,500. Amount is determined using a proprietary calculation based on a user profile 304.
Risk Allocation 224: Example: Secure. Based on the Goal 202, Goal Time Horizon 222 and the user profile 304 a determination will be made regarding the amount of risk (market, political, tax, and liquidity, inflation) the user 300 should assume.
Financial Product Allocation 228: Example: Bank Savings Account=40%, CD's=40%, Cash=20%. Product Allocation 228 is determined by a combination of user profile 304, Risk Allocation 224, Goal Time Horizon 222,
Asset Allocation 230: Example: Large Capital Growth=10%, Large Capital Value=10%, Mid-Capital Blend=15%, Small Capital Growth=10%, Small Capital Value=10%, International Equities=15%, Fixed Income=15%, Cash or Money Market=15%. Asset Allocation 230 will be determined by the user profile 304, Risk Allocation 224, Goal Time Horizon 222 and Financial Product Allocation 228.
Investment Diversification 232: Example: Specific investments. For each asset allocation 230 a grouping of specific investments (equities, mutual funds, fixed income instruments) will be made available to the user 300 for their consideration.
Liquidity 236: Example: 30%. Liquidity % 236 represents the recommended portion of the user 300 investments which can be accessed immediately (such as Cash or Money Market).

The user 300 can choose to customize or add goals 306 based on their situation, expectations, or needs. And, the user 300 can also modify/update their profile 312. Additionally, the user 300 can add the details of any of their existing accounts 314. Examples can include bank, insurance, retirement, or brokerage accounts or policies. The user 300 can also customize their goals and goal elements 316 (while the user 300 will be shown recommended goal elements 310 as a best practice the user 300 can customize those inputs based on their individual situation or preferences).

As the user 300 modifies their profile 312, customizes goal and/or goal elements 316, or provides additional account information 314 the system can continuously and dynamically update recommendations 318 by categorizing 208 and weighting 210 the goals in terms of priority or importance.

The system 200 can then run a series of methods comparing the recommendations 318 against the user's inputs (for goals 200 and goal and goal element details 316 or account details 314). Differences in the recommendations 318 and user inputs 306, 314, 316 can be used to generate goal elements, and goal and plan scores. Based on the goal element scoring system 238, for each relevant goal element the score 241, the user 300 can be presented an illustration 240 and a set of recommendations 246 in priority order to provide guidance on how the user 300 can improve their goal element scores. Based on the goal scoring system 212, for each relevant goal the score 215, the user 300 can also be presented an illustration 214 and a set of recommendations 246 in priority order to provide guidance on how the user 300 can improve their goal scores. An example of this method multiplies the maximum goal element score by a percentage. The percentage, ranging from 10% to 100%, is based on the variations between the recommendations 318 and the user's inputs 316. Based on the plan scoring system 242, the user 300 can be presented a plan score 245, an illustration 244 and a set of recommendations 246 in priority order to provide guidance on how the user 300 can improve their plan score.

From time to time, the user 300 or the system 242 can choose to revisit the service provider system in order to update 322 various elements of the invention and receive refreshed scores, illustrations, and recommendations.

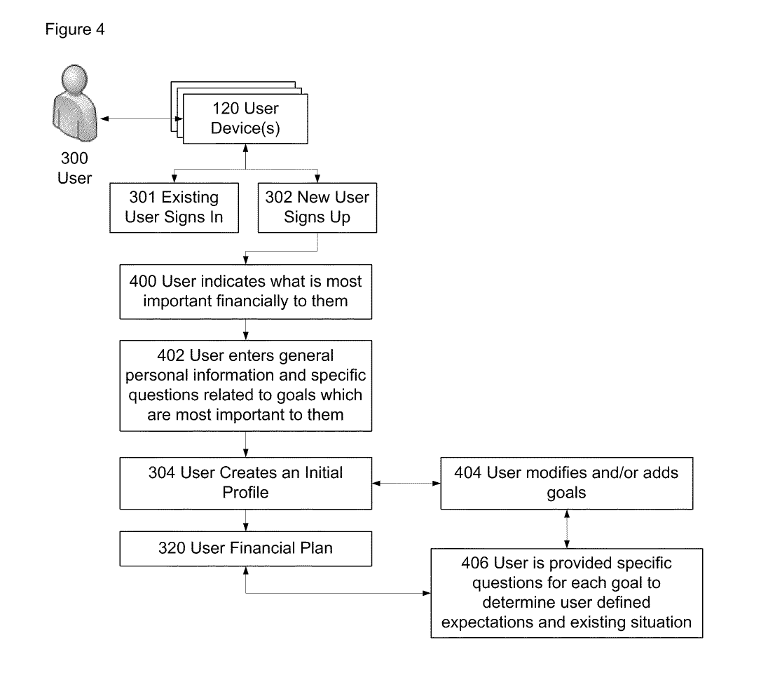

FIG. 4 is a flow chart of an example method for generating or creating and updating the user profile. The user 300 can sign up at 302 using a user device 120 and through a financial service platform or apparatus, can input what financially is most important to them at 400. This input information can be entered from a list of pre-determined responses (e.g., “I want to live debt free,” “I want to provide and protect my family,” “I want to save for college,” “I want to save for a home”) or enter a customized response. And, the user 300 can prioritize their entries at this or a separate step.

Based on what the user has indicated as most financially important to them at 400, the user 300 is prompted to answer additional questions at 402 in order to generate an initial profile at 304. Profiling questions can be both standardized and dynamic based on what is most financially important. Example standardized questions can include: partner or martial status, age, dependent information, income, partner or spouse income, gender, and zip code. Example dynamic questions can include: for users who responded that live debt free was financially important to them, dynamic questions can include: what types of debt do they current have (credit card, home mortgage, car, or other debt) and the outstanding balances for each form of debt they have entered profile information.

The user 300 can modify the profile at any time by providing updated information to existing elements or by adding new goals and goal elements to the user's plan at 404. The user 300 can also add/modify goals at 404. For each goal, the user 300 can be presented with specific profiling questions to determine the user-defined needs, expectations, and current situation at 406, as applicable, for a specific goal. The example method illustrated in FIG. 4 can be utilized as an example implementation to create the user profile at step 304 of FIG. 3, although portions or variations thereof can be utilized in accordance with other example embodiments of the invention.

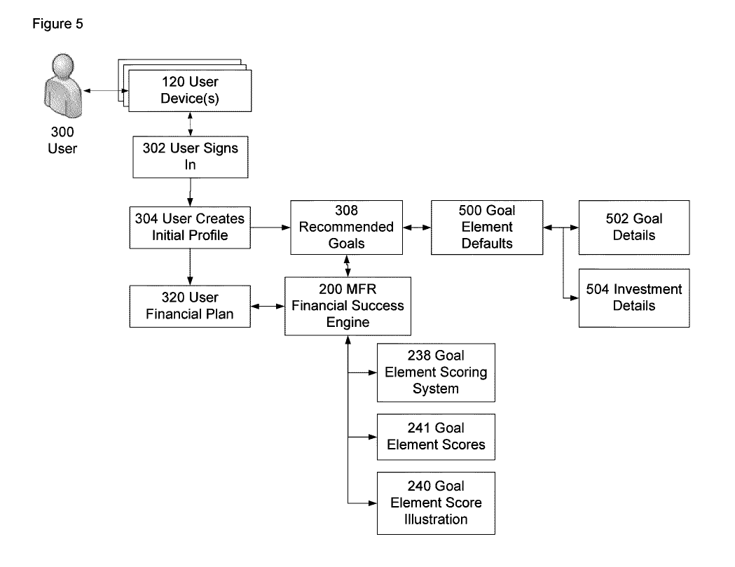

FIG. 5 is a flow chart of one example method for identifying or creating goals at 404 of FIG. 4. The financial service platform or system can present the user 300 with initial goal recommendations 308 based on the user profile 304. Each goal recommendation 308 can contain one or several defaulted elements 500 or details 502 (e.g., goal priority 218, target need 220, recommended savings rate 226, time horizon to achieve goal need 222, amount of savings the user should have accumulated 234) and investment 504 details (e.g., recommended risk allocation 224, financial product allocation 228, high level asset allocation 230, investment diversification 232, and goal liquidity 236). The example method illustrated in FIG. 5 can be utilized as an example implementation for the recommended goals step of FIG. 3, although portions or variations thereof can be utilized in accordance with other example embodiments of the invention.

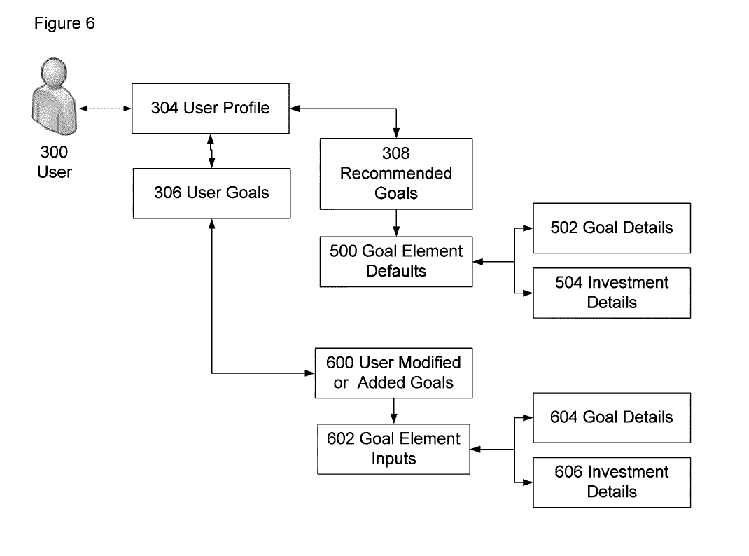

FIG. 6 is a flow chart of an example method for customizing goals at 404 of FIG. 4. The user 300 can choose to modify/customize or add to goals 600. For example, the user 300 can modify or customize the priority of the goal 218, target need 220, how much savings the user 300 will apply to the goal (savings rate) 226, when the user 300 wants to achieve the goal (time horizon) 222, and how much current savings the user 300 has allocated to the goal 234. The user 300 can add new goals 600 or goal elements 602 or needs not in the set of recommended goals to produce new goal details 604 and new investment details 606. The example method illustrated in FIG. 6 can be utilized as an example implementation for User Customize Goals of FIG. 3, although portions or variations thereof can be utilized in accordance with other example embodiments of the invention.

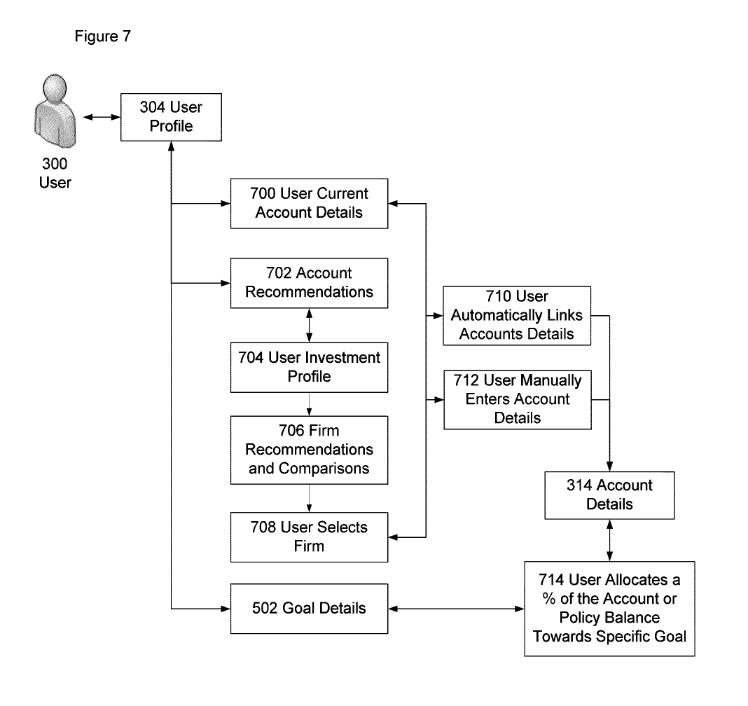

FIG. 7 is a flow chart of an example method for adding the user financial plan accounts at 320 of FIG. 3. Account details 700 can include: investment accounts, insurance policies, bonds, bank accounts, investment properties, etc. . . . The user 300 can add accounts 700 they currently possess or add new accounts. Through the financial plan engine 200 the user 300 can be shown accounts which will improve their financial plan score. For these accounts the user 300 can be asked one or several investment profile questions 704. Based on the answers to the investment profile question(s) 704 the user 300 can be shown several firms 706 which meet the account need or gap. Firm recommendations 706 can be based on the user's investment profile 704, other customer ratings of the various firms, ratings of the various firms, or product capabilities. Through the financial service platform or apparatus, the user 300 can input or link 710 to their financial accounts and their underlying detail information. Alternatively, the user can manually enter 712 their account details. The user can also allocate 714 all or a percentage of each account towards a specific stated goal. For accuracy, each account should be allocated to total 100%. The example method illustrated in FIG. 7 can be utilized as an example implementation for User Account Details of FIG. 3, although portions or variations thereof can be utilized in accordance with other example embodiments of the invention.

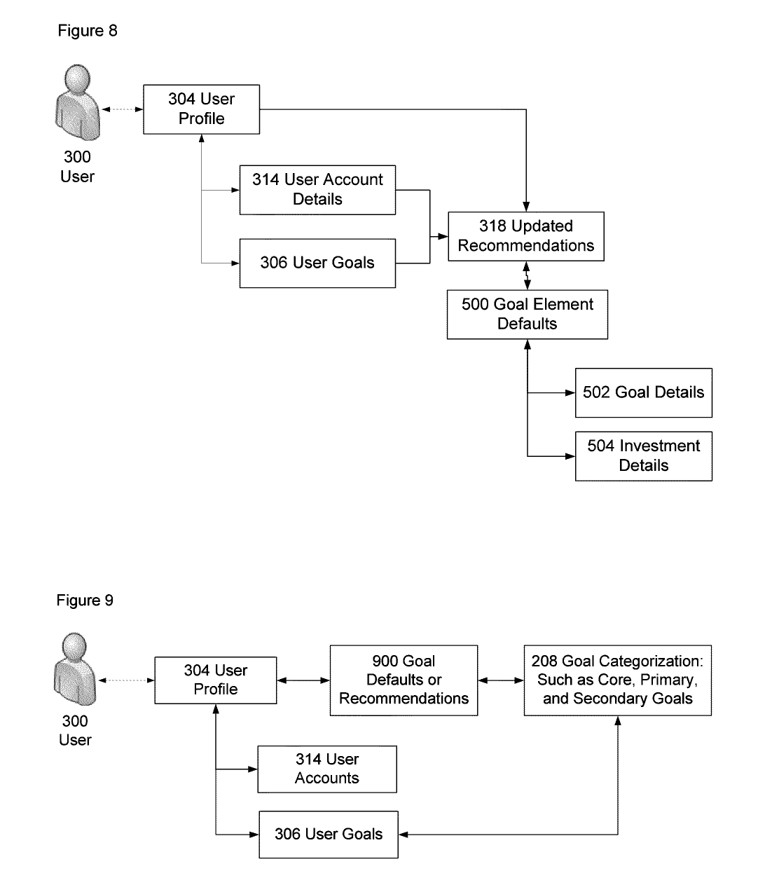

FIG. 8 is a flow chart of an example method for creating updated goal recommendations at 318 of FIG. 3. Based on existing account information/details 314, the user profile 304, and user defined goals 306, the goal recommendations 318 can be updated. The recommendations 318 and goal element defaults 500 and details 502 and investment details 504 can also be updated. The example method illustrated in FIG. 8 can be utilized as an example implementation for Updated Recommendations of FIG. 3, although portions or variations thereof can be utilized in accordance with other example embodiments of the invention.

FIG. 9 is a flow chart of an example method for creating goal categorizations. Goals can be categorized 208 by their priority. Categorization 208 can be represented by funded, NA (non-applicable), core, primary and secondary goals. Example categorization 208 can update the goal defaults or recommendations 900. The example method illustrated in FIG. 9 can be utilized as an example implementation for Goal Categorization of FIG. 3, although portions or variations thereof can be utilized in accordance with other example embodiments of the invention.

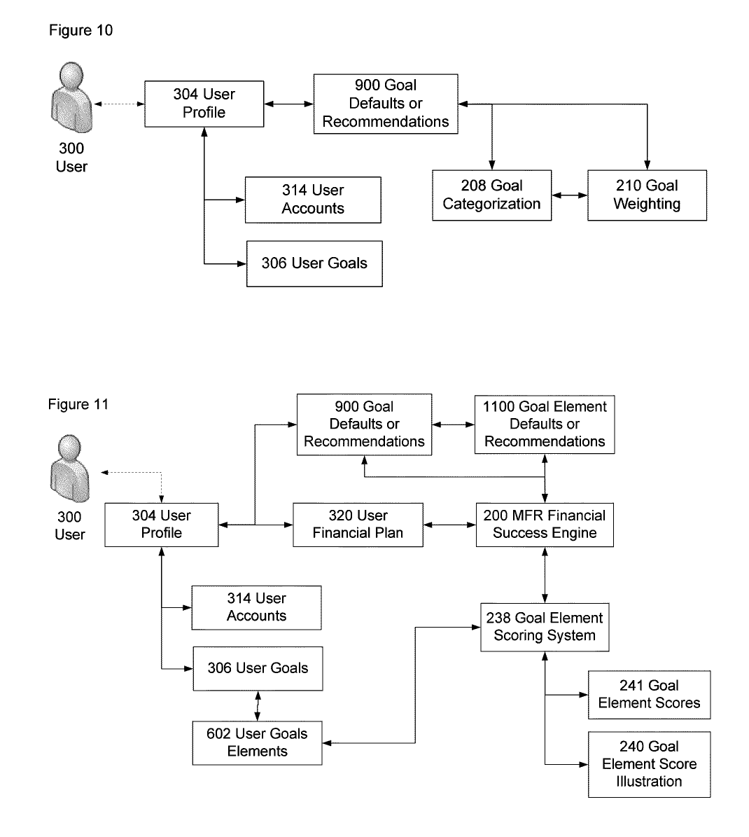

FIG. 10 is a flow chart of one example method for creating goal and goal element weighting. Each goal and each goal element can be weighted based the user's profile 304, the goal's weight/priority 210 and/or categorization 208. Each goal can have a unique goal weighting system. And, each goal can have the ability to generate a maximum of number of points, for example 100 points. The maximum allowable points can be allocated across goal elements 500 based on the user's profile 304 and proprietary weighting system 210.

An example of the goal and goal element weighting methods can include:

TABLE A
Goal Weighting Methododology:

| Weighing | |
|---|---|
| Category | Definition |
| Funded | A goal has meet its target need, no funding is required |
| Core | The top three goals by priority number which are not NA |
| | or Funded |
| Primary | Goals with priority numbers 4, 5 and 6 which are not NA |
| | or Funded |
| Secondary | Goals which are not categorized as Funded, Core, Primary, |
| | or NA |
| NA | Goals which are not applicable based on the user's profile |

TABLE B
Goal Element Weighting Methodology:

| | Weight Categories by Goal Type | | | | |
|---|---|---|---|---|---|
| | Accumu- | | | | |
| | lation | Debt | Insurance | | Home |
| Goal Element | Goals | Goals | Goals | Custom | Purchase |
| Goal Priority | Tier 2 | Tier 3 | Tier 2 | Tier 1 | Tier 2 |
| Goal Savings | Tier 1 | Tier 1 | Tier 1 | Tier 1 | Tier 1 |
| Rate | | | | | |
| Goal Target Need | Tier 1 | NA | Tier 1 | NA | Tier 1 |
| Goal Timing | Tier 4 | Tier 4 | Tier 3 | Tier 3 | Tier 4 |
| Goal Current | Tier 2 | Tier 3 | Tier 2 | Tier 3 | NA |
| Savings | | | | | |
| Investment Risk | Tier 3 | NA | NA | Tier 2 | Tier 2 |
| Allocation | | | | | |
| Investment | Tier 3 | NA | Tier 3 | Tier 2 | Tier 3 |
| Product | | | | | |
| Allocation | | | | | |
| Asset Allocation | Tier 4 | NA | NA | Tier 4 | Tier 3 |
| Investment | Tier 5 | NA | NA | Tier 4 | Tier 4 |
| Diversification | | | | | |
| Liquidity | Tier 5 | NA | NA | Tier 5 | Tier 5 |

TABLE C

| Goal Type | Goals |
|---|---|
| Accumulation Goals | Car-Purchase, College, Emergency Fund, |
| | Retirement, Will |
| Debt Goals | Car-Debt, Debt (general), Home-Debt |
| Insurance Goals | Disability, Life Insurance, Long Term Care |
| Custom | Custom goals |
| Home Purchase | Home-Purchase |

TABLE D

| | Maximum Points per Tier |
|---|---|
| Tier 1 | 50 |
| Tier 2 | 40 |
| Tier 3 | 30 |
| Tier 4 | 20 |
| Tier 5 | 10 |

TABLE E

| | % of Maximum points for |
|---|---|
| Age Segment | Goal Current Savings |
| <18 Years Old | 0% |
| 18 to 22 Years Old | 14% |
| 23 to 25 Years Old | 29% |
| 26 to 30 Years Old | 43% |
| 31 to 35 Years Old | 57% |
| 36 to 40 Years Old | 71% |
| 41 to 45 Years Old | 86% |
| 46 to 50 Years Old | 100% |
| 51 to 55 Years Old | 100% |
| 56 to 60 Years Old | 100% |
| 61 to 65 Years Old | 100% |
| >66 Years Old | 100% |

Method Example: Step 1: [goal element] multiplied by [goal element weight tier maximum points] multiplied by [% of Maximum points for Goal Current Savings element only]. Step 2: Add all goal element points together to obtain total goal points. Step 3: [Individual Goal Element Point Total] multiplied by [100] divided by [Total Goal points] equals the weighted maximum points for a specific goal element.

The example method illustrated in FIG. 10 can be utilized as an example implementation for Goal Weighting of FIG. 3, although portions or variations thereof can be utilized in accordance with other example embodiments of the invention.

FIG. 11 is a flow chart of an example method for creating a goal element score 238 and illustration 240 for each goal element. Each goal element for every goal can be scored. Each goal element can have a potential maximum score, for example 100 points. The recommendation 1100 for each goal element can then be compared to each of the user defined goal elements 900 for every goal. The goal elements 1100 can be weighted based on the user's profile 304, the goal's weight/priority 210 and/or categorization 208. Differences in the comparison between the user input 602 and the default recommendations 900 can be assigned a value, which can be unique for each goal, in order to calculate a score 238. The score 238 can then be further calculated based on the goal element weighting in order to determine the final score. This score can be presented to the user in the form of a score 241 and/or an illustration 240.

An example for how the Goal Elements 216 can be scored can include the following metrics:

TABLE F
Goal Priority Element Scoring:

| | Default or | Results | | | | | | | | | | |
|---|---|---|---|---|---|---|---|---|---|---|---|---|
| User Input | Ideal | | | | | | | | Long | | | |
| Goal | Goal | | | | | Emergency | | Life | Term | | | |
| Category | Category | Car | College | Debt | Disability | Fund | Home | Insurance | Care | Retirement | Will | Custom |
| Core | Core | 100% | 100% | 100% | 100% | 100% | 100% | 100% | 100% | 100% | 100% | 100% |
| Core | Primary | 100% | 100% | 100% | 100% | 100% | 100% | 100% | 100% | 100% | 100% | 100% |
| Core | Secondary | 100% | 100% | 100% | 100% | 100% | 100% | 100% | 100% | 100% | 100% | 100% |
| Core | Funded | 100% | 100% | 100% | 100% | 100% | 100% | 100% | 100% | 100% | 100% | 100% |
| Core | NA | 100% | 100% | 100% | 100% | 100% | 100% | 100% | 100% | 100% | 100% | 100% |
| Primary | Core | 70% | 70% | 70% | 70% | 70% | 70% | 70% | 70% | 70% | 70% | 70% |
| Primary | Primary | 100% | 100% | 100% | 100% | 100% | 100% | 100% | 100% | 100% | 100% | 100% |
| Primary | Secondary | 70% | 70% | 70% | 70% | 70% | 70% | 70% | 70% | 70% | 70% | 70% |
| Primary | Funded | 100% | 100% | 100% | 100% | 100% | 100% | 100% | 100% | 100% | 100% | 100% |
| Primary | NA | 100% | 100% | 100% | 100% | 100% | 100% | 100% | 100% | 100% | 100% | 100% |
| Secondary | Core | 40% | 40% | 40% | 40% | 40% | 40% | 40% | 40% | 40% | 40% | 40% |
| Secondary | Primary | 70% | 70% | 70% | 70% | 70% | 70% | 70% | 70% | 70% | 70% | 70% |
| Secondary | Secondary | 100% | 100% | 100% | 100% | 100% | 100% | 100% | 100% | 100% | 100% | 100% |
| Secondary | Funded | 100% | 100% | 100% | 100% | 100% | 100% | 100% | 100% | 100% | 100% | 100% |
| Secondary | NA | 100% | 100% | 100% | 100% | 100% | 100% | 100% | 100% | 100% | 100% | 100% |
| NA | Core | 0% | 0% | 0% | 0% | 0% | 0% | 0% | 0% | 0% | 0% | 0% |
| NA | Primary | 40% | 40% | 40% | 40% | 40% | 40% | 40% | 40% | 40% | 40% | 40% |
| NA | Secondary | 70% | 70% | 70% | 70% | 70% | 70% | 70% | 70% | 70% | 70% | 70% |
| NA | Funded | 100% | 100% | 100% | 100% | 100% | 100% | 100% | 100% | 100% | 100% | 100% |
| NA | NA | 100% | 100% | 100% | 100% | 100% | 100% | 100% | 100% | 100% | 100% | 100% |
| Funded | Core | 100% | 100% | 100% | 100% | 100% | 100% | 100% | 100% | 100% | 100% | 100% |
| Funded | Primary | 100% | 100% | 100% | 100% | 100% | 100% | 100% | 100% | 100% | 100% | 100% |
| Funded | Secondary | 100% | 100% | 100% | 100% | 100% | 100% | 100% | 100% | 100% | 100% | 100% |
| Funded | Funded | 100% | 100% | 100% | 100% | 100% | 100% | 100% | 100% | 100% | 100% | 100% |
| Funded | NA | 100% | 100% | 100% | 100% | 100% | 100% | 100% | 100% | 100% | 100% | 100% |

TABLE G
Goal Savings Rate Scoring Calculation
The percentages below represent the amount to be applied to the Goal Element
Maximum Point Defaults (in the tables above) for each goal and each goal element.

| | | | | | | Results | | | |
|---|---|---|---|---|---|---|---|---|---|
| | | | | | | Car | | | |
| | Goal Category | | | | | (debt or | | | |
| Calculation | Core | Primary | Secondary | NA | Funded | purchase) | College | Debt | Disability |
| If X = Y | X | X | X | X | X | 100% | 100% | 100% | 100% |
| If X < (Y * 0.95) | X | X | X | X | X | 95% | 95% | 95% | 95% |
| If X < (Y * 0.90) | X | X | X | X | X | 90% | 90% | 90% | 90% |
| If X < (Y * 0.85) | X | X | X | X | X | 85% | 85% | 85% | 85% |
| If X < (Y * 0.80) | X | X | X | X | X | 80% | 80% | 80% | 80% |
| If X < (Y * 0.75) | X | X | X | X | X | 75% | 75% | 75% | 75% |
| If X < (Y * 0.70) | X | X | X | X | X | 70% | 70% | 70% | 70% |
| If X < (Y * 0.65) | X | X | X | X | X | 65% | 65% | 65% | 65% |
| If X < (Y * 0.60) | X | X | X | X | X | 60% | 60% | 60% | 60% |
| If X < (Y * 0.55) | X | X | X | X | X | 55% | 55% | 55% | 55% |
| If X < (Y * 0.50) | X | X | X | X | X | 50% | 50% | 50% | 50% |
| If X < (Y * 0.45) | X | X | X | X | X | 40% | 40% | 40% | 40% |
| If X < (Y * 0.40) | X | X | X | X | X | 30% | 30% | 30% | 30% |
| If X < (Y * 0.35) | X | X | X | X | X | 20% | 20% | 20% | 20% |
| If X < (Y * 0.30) | X | X | X | X | X | 10% | 10% | 10% | 10% |
| If X < (Y * 0.25) | X | X | X | X | X | 0% | 0% | 0% | 0% |
| If X < (Y * 0.20) | X | X | X | X | X | 0% | 0% | 0% | 0% |
| If X < (Y * 0.15) | X | X | X | X | X | 0% | 0% | 0% | 0% |
| If X < (Y * 0.10) | X | X | X | X | X | 0% | 0% | 0% | 0% |
| If X < (Y * 0.05) | X | X | X | X | X | 0% | 0% | 0% | 0% |
| If X < (Y * 0.00) | X | X | X | X | X | 0% | 0% | 0% | 0% |
| If X > Y | X | | | | | 100% | 100% | 100% | 100% |
| If X > (Y * 1.05) | | X | | | | 100% | 100% | 100% | 100% |
| If X > (Y * 1.10) | | X | | | | 100% | 100% | 100% | 100% |
| If X > (Y * 1.15) | | X | | | | 100% | 100% | 100% | 100% |
| If X > (Y * 1.20) | | X | | | | 100% | 100% | 100% | 100% |
| If X > (Y * 1.25) | | X | | | | 100% | 100% | 100% | 100% |
| If X > (Y * 1.30) | | X | | | | 95% | 95% | 95% | 95% |
| If X > (Y * 1.35) | | | | | | 90% | 90% | 90% | 90% |
| If X > (Y * 1.40) | | X | | | | 85% | 85% | 85% | 85% |
| If X > (Y * 1.45) | | X | | | | 80% | 80% | 80% | 80% |
| If X > (Y * 1.50) | | X | | | | 75% | 75% | 75% | 75% |
| If X > (Y * 1.55) | | X | | | | 70% | 70% | 70% | 70% |
| If X > (Y * 1.60) | | X | | | | 65% | 65% | 65% | 65% |
| If X > (Y * 1.65) | | X | | | | 60% | 60% | 60% | 60% |
| If X > (Y * 1.70) | | X | | | | 55% | 55% | 55% | 55% |
| If X > (Y * 1.75) | | X | | | | 50% | 50% | 50% | 50% |
| If X > (Y * 1.80) | | X | | | | 40% | 40% | 40% | 40% |
| If X > (Y * 1.85) | | X | | | | 30% | 30% | 30% | 30% |
| If X > (Y * 1.90) | | X | | | | 20% | 20% | 20% | 20% |
| If X > (Y * 1.95) | | X | | | | 10% | 10% | 10% | 10% |
| If X > (Y * 2.00) | | X | | | | 0% | 0% | 0% | 0% |
| If X > (Y * 1.05) | | | X | | | 100% | 100% | 100% | 100% |
| If X > (Y * 1.10) | | | X | | | 100% | 100% | 100% | 100% |
| If X > (Y * 1.15) | | | X | | | 100% | 100% | 100% | 100% |
| If X > (Y * 1.20) | | | X | | | 90% | 90% | 90% | 90% |
| If X > (Y * 1.25) | | | X | | | 80% | 80% | 80% | 80% |
| If X > (Y * 1.30) | | | X | | | 70% | 70% | 70% | 70% |
| If X > (Y * 1.35) | | | X | | | 60% | 60% | 60% | 60% |
| If X > (Y * 1.40) | | | X | | | 50% | 50% | 50% | 50% |
| If X > (Y * 1.45) | | | X | | | 40% | 40% | 40% | 40% |
| If X > (Y * 1.50) | | | X | | | 30% | 30% | 30% | 30% |
| If X > (Y * 1.55) | | | X | | | 20% | 20% | 20% | 20% |
| If X > (Y * 1.60) | | | X | | | 10% | 10% | 10% | 10% |
| If X > (Y * 1.65) | | | X | | | 0% | 0% | 0% | 0% |
| If X > Y | | | | X | | 0% | 0% | 0% | 0% |
| If X > Y | | | | | X | 0% | 0% | 0% | 0% |

| | Results | | | | | | |
|---|---|---|---|---|---|---|---|
| | | Home | | Long | | | |
| | Emergency | (debt or | Life | Term | | | |
| Calculation | Fund | purchase) | Insurance | Care | Retirement | Will | Custom |
| If X = Y | 100% | 100% | 100% | 100% | 100% | 100% | 100% |
| If X < (Y * 0.95) | 95% | 95% | 95% | 95% | 95% | 95% | 95% |
| If X < (Y * 0.90) | 90% | 90% | 90% | 90% | 90% | 90% | 90% |
| If X < (Y * 0.85) | 85% | 85% | 85% | 85% | 85% | 85% | 85% |
| If X < (Y * 0.80) | 80% | 80% | 80% | 80% | 80% | 80% | 80% |
| If X < (Y * 0.75) | 75% | 75% | 75% | 75% | 75% | 75% | 75% |
| If X < (Y * 0.70) | 70% | 70% | 70% | 70% | 70% | 70% | 70% |
| If X < (Y * 0.65) | 65% | 65% | 65% | 65% | 65% | 65% | 65% |
| If X < (Y * 0.60) | 60% | 60% | 60% | 60% | 60% | 60% | 60% |
| If X < (Y * 0.55) | 55% | 55% | 55% | 55% | 55% | 55% | 55% |
| If X < (Y * 0.50) | 50% | 50% | 50% | 50% | 50% | 50% | 50% |
| If X < (Y * 0.45) | 40% | 40% | 40% | 40% | 40% | 40% | 40% |
| If X < (Y * 0.40) | 30% | 30% | 30% | 30% | 30% | 30% | 30% |
| If X < (Y * 0.35) | 20% | 20% | 20% | 20% | 20% | 20% | 20% |
| If X < (Y * 0.30) | 10% | 10% | 10% | 10% | 10% | 10% | 10% |
| If X < (Y * 0.25) | 0% | 0% | 0% | 0% | 0% | 0% | 0% |
| If X < (Y * 0.20) | 0% | 0% | 0% | 0% | 0% | 0% | 0% |
| If X < (Y * 0.15) | 0% | 0% | 0% | 0% | 0% | 0% | 0% |
| If X < (Y * 0.10) | 0% | 0% | 0% | 0% | 0% | 0% | 0% |
| If X < (Y * 0.05) | 0% | 0% | 0% | 0% | 0% | 0% | 0% |
| If X < (Y * 0.00) | 0% | 0% | 0% | 0% | 0% | 0% | 0% |
| If X > Y | 100% | 100% | 100% | 100% | 100% | 100% | 100% |
| If X > (Y * 1.05) | 100% | 100% | 100% | 100% | 100% | 100% | 100% |
| If X > (Y * 1.10) | 100% | 100% | 100% | 100% | 100% | 100% | 100% |
| If X > (Y * 1.15) | 100% | 100% | 100% | 100% | 100% | 100% | 100% |
| If X > (Y * 1.20) | 100% | 100% | 100% | 100% | 100% | 100% | 100% |
| If X > (Y * 1.25) | 100% | 100% | 100% | 100% | 100% | 100% | 100% |
| If X > (Y * 1.30) | 95% | 95% | 95% | 95% | 95% | 95% | 95% |
| If X > (Y * 1.35) | 90% | 90% | 90% | 90% | 90% | 90% | 90% |
| If X > (Y * 1.40) | 85% | 85% | 85% | 85% | 85% | 85% | 85% |
| If X > (Y * 1.45) | 80% | 80% | 80% | 80% | 80% | 80% | 80% |
| If X > (Y * 1.50) | 75% | 75% | 75% | 75% | 75% | 75% | 75% |
| If X > (Y * 1.55) | 70% | 70% | 70% | 70% | 70% | 70% | 70% |
| If X > (Y * 1.60) | 65% | 65% | 65% | 65% | 65% | 65% | 65% |
| If X > (Y * 1.65) | 60% | 60% | 60% | 60% | 60% | 60% | 60% |
| If X > (Y * 1.70) | 55% | 55% | 55% | 55% | 55% | 55% | 55% |
| If X > (Y * 1.75) | 50% | 50% | 50% | 50% | 50% | 50% | 50% |
| If X > (Y * 1.80) | 40% | 40% | 40% | 40% | 40% | 40% | 40% |
| If X > (Y * 1.85) | 30% | 30% | 30% | 30% | 30% | 30% | 30% |
| If X > (Y * 1.90) | 20% | 20% | 20% | 20% | 20% | 20% | 20% |
| If X > (Y * 1.95) | 10% | 10% | 10% | 10% | 10% | 10% | 10% |
| If X > (Y * 2.00) | 0% | 0% | 0% | 0% | 0% | 0% | 0% |
| If X > (Y * 1.05) | 100% | 100% | 100% | 100% | 100% | 100% | 100% |
| If X > (Y * 1.10) | 100% | 100% | 100% | 100% | 100% | 100% | 100% |
| If X > (Y * 1.15) | 100% | 100% | 100% | 100% | 100% | 100% | 100% |
| If X > (Y * 1.20) | 90% | 90% | 90% | 90% | 90% | 90% | 90% |
| If X > (Y * 1.25) | 80% | 80% | 80% | 80% | 80% | 80% | 80% |
| If X > (Y * 1.30) | 70% | 70% | 70% | 70% | 70% | 70% | 70% |
| If X > (Y * 1.35) | 60% | 60% | 60% | 60% | 60% | 60% | 60% |
| If X > (Y * 1.40) | 50% | 50% | 50% | 50% | 50% | 50% | 50% |
| If X > (Y * 1.45) | 40% | 40% | 40% | 40% | 40% | 40% | 40% |
| If X > (Y * 1.50) | 30% | 30% | 30% | 30% | 30% | 30% | 30% |
| If X > (Y * 1.55) | 20% | 20% | 20% | 20% | 20% | 20% | 20% |
| If X > (Y * 1.60) | 10% | 10% | 10% | 10% | 10% | 10% | 10% |
| If X > (Y * 1.65) | 0% | 0% | 0% | 0% | 0% | 0% | 0% |
| If X > Y | 0% | 0% | 0% | 0% | 0% | 0% | 0% |
| If X > Y | 0% | 0% | 0% | 0% | 0% | 0% | 0% |

X = User Input;
Y = Default and Ideal inputs.
Values are measured in dollars

TABLE H
Goal Target Need Scoring Calculation

| | Results | | | | | | | | | | |
|---|---|---|---|---|---|---|---|---|---|---|---|
| | | | | | Emergency | | Life | Long Term | | | |
| Calculation | Car | College | Debt | Disability | Fund | Home | Insurance | Care | Retirement | Will | Custom |
| If X = Y | 100% | 100% | NA | 100% | 100% | 100% | 100% | 100% | 100% | 100% | NA |
| If X < (Y * 0.95) | 100% | 100% | NA | 100% | 90% | 100% | 100% | 100% | 90% | 90% | NA |
| If X < (Y * 0.90) | 100% | 100% | NA | 100% | 80% | 100% | 100% | 100% | 80% | 80% | NA |
| If X < (Y * 0.85) | 100% | 100% | NA | 100% | 70% | 100% | 100% | 100% | 70% | 70% | NA |
| If X < (Y * 0.80) | 100% | 100% | NA | 100% | 60% | 100% | 100% | 100% | 60% | 60% | NA |
| If X < (Y * 0.75) | 100% | 100% | NA | 100% | 50% | 100% | 100% | 100% | 50% | 50% | NA |
| If X < (Y * 0.70) | 100% | 95% | NA | 95% | 40% | 100% | 95% | 95% | 40% | 40% | NA |
| If X < (Y * 0.65) | 100% | 90% | NA | 90% | 30% | 100% | 90% | 90% | 30% | 30% | NA |
| If X < (Y * 0.60) | 100% | 80% | NA | 80% | 20% | 100% | 80% | 80% | 20% | 20% | NA |
| If X < (Y * 0.55) | 100% | 70% | NA | 70% | 10% | 100% | 70% | 70% | 10% | 10% | NA |
| If X < (Y * 0.50) | 100% | 60% | NA | 60% | 0% | 100% | 60% | 60% | 0% | 0% | NA |
| If X < (Y * 0.45) | 95% | 50% | NA | 50% | 0% | 95% | 50% | 50% | 0% | 0% | NA |
| If X < (Y * 0.40) | 90% | 40% | NA | 40% | 0% | 90% | 40% | 40% | 0% | 0% | NA |
| If X < (Y * 0.35) | 85% | 30% | NA | 30% | 0% | 85% | 30% | 30% | 0% | 0% | NA |
| If X < (Y * 0.30) | 80% | 20% | NA | 20% | 0% | 80% | 20% | 20% | 0% | 0% | NA |
| If X < (Y * 0.25) | 75% | 10% | NA | 10% | 0% | 75% | 10% | 10% | 0% | 0% | NA |
| If X < (Y * 0.20) | 70% | 0% | NA | 0% | 0% | 70% | 0% | 0% | 0% | 0% | NA |
| If X < (Y * 0.15) | 65% | 0% | NA | 0% | 0% | 65% | 0% | 0% | 0% | 0% | NA |
| If X < (Y * 0.10) | 60% | 0% | NA | 0% | 0% | 60% | 0% | 0% | 0% | 0% | NA |
| If X < (Y * 0.05) | 55% | 0% | NA | 0% | 0% | 55% | 0% | 0% | 0% | 0% | NA |
| If X < (Y * 0.00) | 50% | 0% | NA | 0% | 0% | 50% | 0% | 0% | 0% | 0% | NA |
| If X > (Y * 1.05) | 90% | 100% | NA | 100% | 100% | 80% | 100% | 100% | 100% | 100% | NA |
| If X > (Y * 1.10) | 80% | 100% | NA | 100% | 100% | 60% | 100% | 100% | 100% | 100% | NA |
| If X > (Y * 1.15) | 60% | 100% | NA | 100% | 100% | 40% | 100% | 100% | 100% | 100% | NA |
| If X > (Y * 1.20) | 40% | 100% | NA | 100% | 100% | 20% | 100% | 100% | 100% | 100% | NA |
| If X > (Y * 1.25) | 20% | 100% | NA | 100% | 100% | 0% | 100% | 100% | 100% | 100% | NA |
| If X > (Y * 1.30) | 0% | 95% | NA | 95% | 95% | 0% | 95% | 95% | 95% | 95% | NA |
| If X > (Y * 1.35) | 0% | 90% | NA | 90% | 90% | 0% | 90% | 90% | 90% | 90% | NA |
| If X > (Y * 1.40) | 0% | 85% | NA | 85% | 85% | 0% | 85% | 85% | 85% | 85% | NA |
| If X > (Y * 1.45) | 0% | 80% | NA | 80% | 80% | 0% | 80% | 80% | 80% | 80% | NA |
| If X > (Y * 1.50) | 0% | 70% | NA | 70% | 70% | 0% | 70% | 70% | 70% | 70% | NA |
| If X > (Y * 1.55) | 0% | 60% | NA | 60% | 60% | 0% | 60% | 60% | 60% | 60% | NA |
| If X > (Y * 1.60) | 0% | 50% | NA | 50% | 50% | 0% | 50% | 50% | 50% | 50% | NA |
| If X > (Y * 1.65) | 0% | 40% | NA | 40% | 40% | 0% | 40% | 40% | 40% | 40% | NA |
| If X > (Y * 1.70) | 0% | 30% | NA | 30% | 30% | 0% | 30% | 30% | 30% | 30% | NA |
| If X > (Y * 1.75) | 0% | 30% | NA | 30% | 30% | 0% | 30% | 30% | 30% | 30% | NA |
| If X > (Y * 1.80) | 0% | 30% | NA | 30% | 30% | 0% | 30% | 30% | 30% | 30% | NA |
| If X > (Y * 1.85) | 0% | 30% | NA | 30% | 30% | 0% | 30% | 30% | 30% | 30% | NA |
| If X > (Y * 1.90) | 0% | 30% | NA | 30% | 30% | 0% | 30% | 30% | 30% | 30% | NA |
| If X > (Y * 1.95) | 0% | 30% | NA | 30% | 30% | 0% | 30% | 30% | 30% | 30% | NA |
| If X > (Y * 2.00) | 0% | 30% | NA | 30% | 30% | 0% | 30% | 30% | 30% | 30% | NA |

(Note: Car - debt, Home - mortgage/debt and debt will have a target need of $0)
X = User Input;
Y = Default and Ideal inputs.
Values are measured in dollars

TABLE I
Goal Time Horizon Scoring Calculation

| | Results | | | | | | | | | | |
|---|---|---|---|---|---|---|---|---|---|---|---|
| | | | | | Emergency | | Life | Long Term | | | |
| Calculation | Car | College | Debt | Disability | Fund | Home | Insurance | Care | Retirement | Will | Custom |
| If X = Y | 100% | 100% | 100% | 100% | 100% | 100% | 100% | 100% | 100% | 100% | 100% |
| If X < (Y * 0.95) | 100% | 100% | 100% | 100% | 100% | 100% | 100% | 100% | 100% | 100% | 100% |
| If X < (Y * 0.90) | 100% | 100% | 100% | 100% | 100% | 100% | 100% | 100% | 100% | 100% | 100% |
| If X < (Y * 0.85) | 100% | 100% | 100% | 100% | 100% | 100% | 100% | 100% | 100% | 100% | 100% |
| If X < (Y * 0.80) | 100% | 100% | 100% | 100% | 100% | 100% | 100% | 100% | 100% | 100% | 100% |
| If X < (Y * 0.75) | 100% | 100% | 100% | 100% | 100% | 100% | 100% | 100% | 100% | 100% | 90% |
| If X < (Y * 0.70) | 90% | 90% | 100% | 90% | 100% | 90% | 90% | 90% | 90% | 90% | 80% |
| If X < (Y * 0.65) | 80% | 80% | 100% | 80% | 100% | 80% | 80% | 80% | 80% | 80% | 70% |
| If X < (Y * 0.60) | 70% | 70% | 100% | 70% | 100% | 70% | 70% | 70% | 70% | 70% | 60% |
| If X < (Y * 0.55) | 60% | 60% | 100% | 60% | 100% | 60% | 60% | 60% | 60% | 60% | 50% |
| If X < (Y * 0.50) | 50% | 50% | 100% | 50% | 100% | 50% | 50% | 50% | 50% | 50% | 40% |
| If X < (Y * 0.45) | 40% | 40% | 90% | 40% | 90% | 40% | 40% | 40% | 40% | 40% | 30% |
| If X < (Y * 0.40) | 30% | 30% | 80% | 30% | 80% | 30% | 30% | 30% | 30% | 30% | 20% |
| If X < (Y * 0.35) | 20% | 20% | 70% | 20% | 70% | 20% | 20% | 20% | 20% | 20% | 10% |
| If X < (Y * 0.30) | 10% | 10% | 60% | 10% | 60% | 10% | 10% | 10% | 10% | 10% | 0% |
| If X < (Y * 0.25) | 0% | 0% | 50% | 0% | 50% | 0% | 0% | 0% | 0% | 0% | 0% |
| If X < (Y * 0.20) | 0% | 0% | 40% | 0% | 40% | 0% | 0% | 0% | 0% | 0% | 0% |
| If X < (Y * 0.15) | 0% | 0% | 30% | 0% | 30% | 0% | 0% | 0% | 0% | 0% | 0% |
| If X < (Y * 0.10) | 0% | 0% | 20% | 0% | 20% | 0% | 0% | 0% | 0% | 0% | 0% |
| If X < (Y * 0.05) | 0% | 0% | 10% | 0% | 10% | 0% | 0% | 0% | 0% | 0% | 0% |
| If X < (Y * 0.00) | 0% | 0% | 0% | 0% | 0% | 0% | 0% | 0% | 0% | 0% | 0% |
| If X > (Y * 1.05) | 90% | 90% | 90% | 90% | 90% | 90% | 90% | 90% | 90% | 90% | 90% |
| If X > (Y * 1.10) | 80% | 80% | 80% | 80% | 80% | 80% | 80% | 80% | 80% | 80% | 80% |
| If X > (Y * 1.15) | 70% | 70% | 70% | 70% | 70% | 70% | 70% | 70% | 70% | 70% | 70% |
| If X > (Y * 1.20) | 60% | 60% | 60% | 60% | 60% | 60% | 60% | 60% | 60% | 60% | 60% |
| If X > (Y * 1.25) | 50% | 50% | 50% | 50% | 50% | 50% | 50% | 50% | 50% | 50% | 50% |
| If X > (Y * 1.30) | 40% | 40% | 40% | 40% | 40% | 40% | 40% | 40% | 40% | 40% | 40% |
| If X > (Y * 1.35) | 30% | 30% | 30% | 30% | 30% | 30% | 30% | 30% | 30% | 30% | 30% |
| If X > (Y * 1.40) | 20% | 20% | 20% | 20% | 20% | 20% | 20% | 20% | 20% | 20% | 20% |
| If X > (Y * 1.45) | 10% | 10% | 10% | 10% | 10% | 10% | 10% | 10% | 10% | 10% | 10% |
| If X > (Y * 1.50) | 0% | 0% | 0% | 0% | 0% | 0% | 0% | 0% | 0% | 0% | 0% |
| If X > (Y * 1.55) | 0% | 0% | 0% | 0% | 0% | 0% | 0% | 0% | 0% | 0% | 0% |
| If X > (Y * 1.60) | 0% | 0% | 0% | 0% | 0% | 0% | 0% | 0% | 0% | 0% | 0% |
| If X > (Y * 1.65) | 0% | 0% | 0% | 0% | 0% | 0% | 0% | 0% | 0% | 0% | 0% |
| If X > (Y * 1.70) | 0% | 0% | 0% | 0% | 0% | 0% | 0% | 0% | 0% | 0% | 0% |
| If X > (Y * 1.75) | 0% | 0% | 0% | 0% | 0% | 0% | 0% | 0% | 0% | 0% | 0% |
| If X > (Y * 1.80) | 0% | 0% | 0% | 0% | 0% | 0% | 0% | 0% | 0% | 0% | 0% |
| If X > (Y * 1.85) | 0% | 0% | 0% | 0% | 0% | 0% | 0% | 0% | 0% | 0% | 0% |
| If X > (Y * 1.90) | 0% | 0% | 0% | 0% | 0% | 0% | 0% | 0% | 0% | 0% | 0% |
| If X > (Y * 1.95) | 0% | 0% | 0% | 0% | 0% | 0% | 0% | 0% | 0% | 0% | 0% |
| If X > (Y * 2.00) | 0% | 0% | 0% | 0% | 0% | 0% | 0% | 0% | 0% | 0% | 0% |

X = User Input;
Y = Default and Ideal inputs.
Values are measured in dollars

TABLE J
Goal Current Savings Scoring Calculation

| | Results | | | | | | | | | | |
|---|---|---|---|---|---|---|---|---|---|---|---|
| | Car | | | | | Home | | | | | |
| | (debt or | | | | Emergency | (debt | | Long Term | | | |
| Calculation | purchase) | College | Debt | Disability | Fund | or purchase) | Life Insurance | Care | Retirement | Will | Custom |
| If X = Y | 100% | 100% | 100% | 100% | 100% | 100% | 100% | 100% | 100% | 100% | 100% |
| If X < (Y * 0.95) | 95% | 95% | 95% | 95% | 95% | 95% | 95% | 95% | 95% | 95% | 95% |
| If X < (Y * 0.90) | 90% | 90% | 90% | 90% | 90% | 90% | 90% | 90% | 90% | 90% | 90% |
| If X < (Y * 0.85) | 85% | 85% | 85% | 85% | 85% | 85% | 85% | 85% | 85% | 85% | 85% |
| If X < (Y * 0.80) | 80% | 80% | 80% | 80% | 80% | 80% | 80% | 80% | 80% | 80% | 80% |
| If X < (Y * 0.75) | 75% | 75% | 75% | 75% | 75% | 75% | 75% | 75% | 75% | 75% | 75% |
| If X < (Y * 0.70) | 70% | 70% | 70% | 70% | 70% | 70% | 70% | 70% | 70% | 70% | 70% |
| If X < (Y * 0.65) | 65% | 65% | 65% | 65% | 65% | 65% | 65% | 65% | 65% | 65% | 65% |
| If X < (Y * 0.60) | 60% | 60% | 60% | 60% | 60% | 60% | 60% | 60% | 60% | 60% | 60% |
| If X < (Y * 0.55) | 55% | 55% | 55% | 55% | 55% | 55% | 55% | 55% | 55% | 55% | 55% |
| If X < (Y * 0.50) | 50% | 50% | 50% | 50% | 50% | 50% | 50% | 50% | 50% | 50% | 50% |
| If X < (Y * 0.45) | 40% | 40% | 40% | 40% | 40% | 40% | 40% | 40% | 40% | 40% | 40% |
| If X < (Y * 0.40) | 30% | 30% | 30% | 30% | 30% | 30% | 30% | 0% | 30% | 30% | 30% |
| If X < (Y * 0.35) | 20% | 20% | 20% | 20% | 20% | 20% | 20% | 20% | 20% | 20% | 20% |
| If X < (Y * 0.30) | 10% | 10% | 10% | 10% | 10% | 10% | 10% | 10% | 10% | 10% | 10% |
| If X < (Y * 0.25) | 0% | 0% | 0% | 0% | 0% | 0% | 0% | 0% | 0% | 0% | 0% |
| If X < (Y * 0.20) | 0% | 0% | 0% | 0% | 0% | 0% | 0% | 0% | 0% | 0% | 0% |
| If X < (Y * 0.15) | 0% | 0% | 0% | 0% | 0% | 0% | 0% | 0% | 0% | 0% | 0% |
| If X < (Y * 0.10) | 0% | 0% | 0% | 0% | 0% | 0% | 0% | 0% | 0% | 0% | 0% |
| If X < (Y * 0.05) | 0% | 0% | 0% | 0% | 0% | 0% | 0% | 0% | 0% | 0% | 0% |
| If X < (Y * 0.00) | 0% | 0% | 0% | 0% | 0% | 0% | 0% | 0% | 0% | 0% | 0% |
| If X > (Y * 1.05) | 100% | 100% | 100% | 100% | 100% | 100% | 100% | 100% | 100% | 100% | 100% |
| If X > (Y * 1.10) | 100% | 100% | 100% | 100% | 100% | 100% | 100% | 100% | 100% | 100% | 100% |
| If X > (Y * 1.15) | 100% | 100% | 100% | 100% | 100% | 100% | 100% | 100% | 100% | 100% | 100% |
| If X > (Y * 1.20) | 100% | 100% | 100% | 100% | 100% | 100% | 100% | 100% | 100% | 100% | 100% |
| If X > (Y * 1.25) | 100% | 100% | 100% | 100% | 100% | 100% | 100% | 100% | 100% | 100% | 100% |
| If X > (Y * 1.30) | 100% | 100% | 100% | 100% | 100% | 100% | 100% | 100% | 100% | 100% | 100% |
| If X > (Y * 1.35) | 100% | 100% | 100% | 100% | 100% | 100% | 100% | 100% | 100% | 100% | 100% |
| If X > (Y * 1.40) | 100% | 100% | 100% | 100% | 100% | 100% | 100% | 100% | 100% | 100% | 100% |
| If X > (Y * 1.45) | 100% | 100% | 100% | 100% | 100% | 100% | 100% | 100% | 100% | 100% | 100% |
| If X > (Y * 1.50) | 100% | 100% | 100% | 100% | 100% | 100% | 100% | 100% | 100% | 100% | 100% |
| If X > (Y * 1.55) | 100% | 100% | 100% | 100% | 100% | 100% | 100% | 100% | 100% | 100% | 100% |
| If X > (Y * 1.60) | 100% | 100% | 100% | 100% | 100% | 100% | 100% | 100% | 100% | 100% | 100% |
| If X > (Y * 1.65) | 100% | 100% | 100% | 100% | 100% | 100% | 100% | 100% | 100% | 100% | 100% |
| If X > (Y * 1.70) | 100% | 100% | 100% | 100% | 100% | 100% | 100% | 100% | 100% | 100% | 100% |
| If X > (Y * 1.75) | 100% | 100% | 100% | 100% | 100% | 100% | 100% | 100% | 100% | 100% | 100% |
| If X > (Y * 1.80) | 100% | 100% | 100% | 100% | 100% | 100% | 100% | 100% | 100% | 100% | 100% |
| If X > (Y * 1.85) | 100% | 100% | 100% | 100% | 100% | 100% | 100% | 100% | 100% | 100% | 100% |
| If X > (Y * 1.90) | 100% | 100% | 100% | 100% | 100% | 100% | 100% | 100% | 100% | 100% | 100% |
| If X > (Y * 1.95) | 100% | 100% | 100% | 100% | 100% | 100% | 100% | 100% | 100% | 100% | 100% |
| If X > (Y * 2.00) | 100% | 100% | 100% | 100% | 100% | 100% | 100% | 100% | 100% | 100% | 100% |

X = User Input;
Y = Default and Ideal inputs.
Values are measured in dollars

TABLE K
Investment Risk Scoring Calculation

| | Iplan Guidance/Defaults | | | User Inputs | | | |
|---|---|---|---|---|---|---|---|
| Goal Time | | Partial | Market | | | Market | |
| Horizon | Secure | Secure | Exposure | Secure | Partial Secure | Exposure | Score |
| Funded | 100% | 0% | 0% | 100% | 0% | 0% | 100% |
| Funded | 100% | 0% | 0% | >80% | 0% | <20% | 80% |
| Funded | 100% | 0% | 0% | >80% | <10% | <20% | 85% |
| Funded | 100% | 0% | 0% | >80% | <20% | <10% | 85% |
| Funded | 100% | 0% | 0% | >80% | <20% | 0% | 90% |
| Funded | 100% | 0% | 0% | >60% | 0% | <40% | 60% |
| Funded | 100% | 0% | 0% | >60% | <10% | <40% | 65% |
| Funded | 100% | 0% | 0% | >60% | <20% | <30% | 70% |
| Funded | 100% | 0% | 0% | >60% | <30% | <20% | 75% |
| Funded | 100% | 0% | 0% | >60% | <40% | <10% | 75% |
| Funded | 100% | 0% | 0% | >60% | <40% | 0% | 80% |
| Funded | 100% | 0% | 0% | >40% | 0% | <60% | 40% |
| Funded | 100% | 0% | 0% | >40% | <10% | <60% | 45% |
| Funded | 100% | 0% | 0% | >40% | <20% | <50% | 50% |
| Funded | 100% | 0% | 0% | >40% | <30% | <40% | 55% |
| Funded | 100% | 0% | 0% | >40% | <40% | <30% | 60% |
| Funded | 100% | 0% | 0% | >40% | <50% | <20% | 65% |
| Funded | 100% | 0% | 0% | >40% | <60% | <10% | 65% |
| Funded | 100% | 0% | 0% | >40% | <60% | 0% | 70% |
| Funded | 100% | 0% | 0% | >20% | 0% | <80% | 20% |
| Funded | 100% | 0% | 0% | >20% | <10% | <80% | 25% |
| Funded | 100% | 0% | 0% | >20% | <20% | <70% | 30% |
| Funded | 100% | 0% | 0% | >20% | <30% | <60% | 35% |
| Funded | 100% | 0% | 0% | >20% | <40% | <50% | 40% |
| Funded | 100% | 0% | 0% | >20% | <50% | <40% | 45% |
| Funded | 100% | 0% | 0% | >20% | <60% | <30% | 45% |
| Funded | 100% | 0% | 0% | >20% | <70% | <20% | 50% |
| Funded | 100% | 0% | 0% | >20% | <80% | <10% | 55% |
| Funded | 100% | 0% | 0% | >20% | <80% | 0% | 60% |
| Funded | 100% | 0% | 0% | >0% | 0% | 100% | 0% |
| Funded | 100% | 0% | 0% | >0% | <10% | <100 | 5% |
| Funded | 100% | 0% | 0% | >0% | <20% | <90% | 10% |
| Funded | 100% | 0% | 0% | >0% | <30% | <80% | 15% |
| Funded | 100% | 0% | 0% | >0% | <40% | <70% | 20% |
| Funded | 100% | 0% | 0% | >0% | <50% | <60% | 25% |
| Funded | 100% | 0% | 0% | >0% | <60% | <50% | 30% |
| Funded | 100% | 0% | 0% | >0% | <70% | <40% | 35% |
| Funded | 100% | 0% | 0% | >0% | <80% | <30% | 40% |
| Funded | 100% | 0% | 0% | >0% | <90% | <20% | 45% |
| Funded | 100% | 0% | 0% | >0% | <100% | <10% | 45% |
| Funded | 100% | 0% | 0% | 0% | 100% | 0% | 50% |

TABLE L

| | Iplan Guidance/Defaults | | | User Inputs | | | |
|---|---|---|---|---|---|---|---|
| Goal Time | | Partial | Market | | | Market | |
| Horizon | Secure | Secure | Exposure | Secure | Partial Secure | Exposure | Score |
| <5 Years | 75% | 25% | 0% | 100% | 0% | 0% | 100% |
| <5 Years | 75% | 25% | 0% | >80% | 0% | <20% | 85% |
| <5 Years | 75% | 25% | 0% | >80% | <10% | <20% | 90% |
| <5 Years | 75% | 25% | 0% | >80% | <20% | <10% | 95% |
| <5 Years | 75% | 25% | 0% | >80% | <20% | 0% | 100% |
| <5 Years | 75% | 25% | 0% | >60% | 0% | <40% | 75% |
| <5 Years | 75% | 25% | 0% | >60% | <10% | <40% | 80% |
| <5 Years | 75% | 25% | 0% | >60% | <20% | <30% | 85% |
| <5 Years | 75% | 25% | 0% | >60% | <30% | <20% | 90% |
| <5 Years | 75% | 25% | 0% | >60% | <40% | <10% | 95% |
| <5 Years | 75% | 25% | 0% | >60% | <40% | 0% | 100% |
| <5 Years | 75% | 25% | 0% | >40% | 0% | <60% | 50% |
| <5 Years | 75% | 25% | 0% | >40% | <10% | <60% | 55% |
| <5 Years | 75% | 25% | 0% | >40% | <20% | <50% | 60% |
| <5 Years | 75% | 25% | 0% | >40% | <30% | <40% | 65% |
| <5 Years | 75% | 25% | 0% | >40% | <40% | <30% | 70% |
| <5 Years | 75% | 25% | 0% | >40% | <50% | <20% | 75% |
| <5 Years | 75% | 25% | 0% | >40% | <60% | <10% | 80% |
| <5 Years | 75% | 25% | 0% | >40% | <60% | 0% | 85% |
| <5 Years | 75% | 25% | 0% | >20% | 0% | <80% | 20% |
| <5 Years | 75% | 25% | 0% | >20% | <10% | <80% | 25% |
| <5 Years | 75% | 25% | 0% | >20% | <20% | <70% | 30% |
| <5 Years | 75% | 25% | 0% | >20% | <30% | <60% | 35% |
| <5 Years | 75% | 25% | 0% | >20% | <40% | <50% | 40% |
| <5 Years | 75% | 25% | 0% | >20% | <50% | <40% | 45% |
| <5 Years | 75% | 25% | 0% | >20% | <60% | <30% | 50% |
| <5 Years | 75% | 25% | 0% | >20% | <70% | <20% | 55% |
| <5 Years | 75% | 25% | 0% | >20% | <80% | <10% | 60% |
| <5 Years | 75% | 25% | 0% | >20% | <80% | 0% | 65% |
| <5 Years | 75% | 25% | 0% | >0% | 0% | 100% | 0% |
| <5 Years | 75% | 25% | 0% | >0% | <10% | <100 | 5% |
| <5 Years | 75% | 25% | 0% | >0% | <20% | <90% | 10% |
| <5 Years | 75% | 25% | 0% | >0% | <30% | <80% | 15% |
| <5 Years | 75% | 25% | 0% | >0% | <40% | <70% | 20% |
| <5 Years | 75% | 25% | 0% | >0% | <50% | <60% | 25% |
| <5 Years | 75% | 25% | 0% | >0% | <60% | <50% | 30% |
| <5 Years | 75% | 25% | 0% | >0% | <70% | <40% | 35% |
| <5 Years | 75% | 25% | 0% | >0% | <80% | <30% | 40% |
| <5 Years | 75% | 25% | 0% | >0% | <90% | <20% | 45% |
| <5 Years | 75% | 25% | 0% | >0% | <100% | <10% | 50% |
| <5 Years | 75% | 25% | 0% | 0% | 100% | 0% | 55% |

TABLE M

| | Iplan Guidance/Defaults | | | User Inputs | | | |
|---|---|---|---|---|---|---|---|
| Goal Time | | Partial | Market | | Partial | Market | |
| Horizon | Secure | Secure | Exposure | Secure | Secure | Exposure | Score |
| 5 to 10 Years | 10% | 30% | 60% | 100% | 0% | 0% | 25% |
| 5 to 10 Years | 10% | 30% | 60% | >80% | 0% | <20% | 30% |
| 5 to 10 Years | 10% | 30% | 60% | >80% | <10% | <20% | 35% |
| 5 to 10 Years | 10% | 30% | 60% | >80% | <20% | <10% | 35% |
| 5 to 10 Years | 10% | 30% | 60% | >80% | <20% | 0% | 20% |
| 5 to 10 Years | 10% | 30% | 60% | >60% | 0% | <40% | 50% |
| 5 to 10 Years | 10% | 30% | 60% | >60% | <10% | <40% | 45% |
| 5 to 10 Years | 10% | 30% | 60% | >60% | <20% | <30% | 40% |
| 5 to 10 Years | 10% | 30% | 60% | >60% | <30% | <20% | 35% |
| 5 to 10 Years | 10% | 30% | 60% | >60% | <40% | <10% | 30% |
| 5 to 10 Years | 10% | 30% | 60% | >60% | <40% | 0% | 30% |
| 5 to 10 Years | 10% | 30% | 60% | >40% | 0% | <60% | 60% |
| 5 to 10 Years | 10% | 30% | 60% | >40% | <10% | <60% | 55% |
| 5 to 10 Years | 10% | 30% | 60% | >40% | <20% | <50% | 60% |
| 5 to 10 Years | 10% | 30% | 60% | >40% | <30% | <40% | 55% |
| 5 to 10 Years | 10% | 30% | 60% | >40% | <40% | <30% | 45% |
| 5 to 10 Years | 10% | 30% | 60% | >40% | <50% | <20% | 35% |
| 5 to 10 Years | 10% | 30% | 60% | >40% | <60% | <10% | 25% |
| 5 to 10 Years | 10% | 30% | 60% | >40% | <60% | 0% | 15% |
| 5 to 10 Years | 10% | 30% | 60% | >20% | 0% | <80% | 90% |
| 5 to 10 Years | 10% | 30% | 60% | >20% | <10% | <80% | 95% |
| 5 to 10 Years | 10% | 30% | 60% | >20% | <20% | <70% | 90% |
| 5 to 10 Years | 10% | 30% | 60% | >20% | <30% | <60% | 80% |
| 5 to 10 Years | 10% | 30% | 60% | >20% | <40% | <50% | 75% |
| 5 to 10 Years | 10% | 30% | 60% | >20% | <50% | <40% | 65% |
| 5 to 10 Years | 10% | 30% | 60% | >20% | <60% | <30% | 55% |
| 5 to 10 Years | 10% | 30% | 60% | >20% | <70% | <20% | 45% |
| 5 to 10 Years | 10% | 30% | 60% | >20% | <80% | <10% | 35% |
| 5 to 10 Years | 10% | 30% | 60% | >20% | <80% | 0% | 25% |
| 5 to 10 Years | 10% | 30% | 60% | 0% | 0% | 100% | 80% |
| 5 to 10 Years | 10% | 30% | 60% | >0% | <10% | <100 | 85% |
| 5 to 10 Years | 10% | 30% | 60% | >0% | <20% | <90% | 90% |
| 5 to 10 Years | 10% | 30% | 60% | >0% | <30% | <80% | 95% |
| 5 to 10 Years | 10% | 30% | 60% | >0% | <40% | <70% | 100% |
| 5 to 10 Years | 10% | 30% | 60% | >0% | <50% | <60% | 100% |
| 5 to 10 Years | 10% | 30% | 60% | >0% | <60% | <50% | 90% |
| 5 to 10 Years | 10% | 30% | 60% | >0% | <70% | <40% | 75% |
| 5 to 10 Years | 10% | 30% | 60% | >0% | <80% | <30% | 65% |
| 5 to 10 Years | 10% | 30% | 60% | >0% | <90% | <20% | 55% |
| 5 to 10 Years | 10% | 30% | 60% | >0% | <100% | <10% | 45% |
| 5 to 10 Years | 10% | 30% | 60% | 0% | 100% | 0% | 40% |

TABLE N

| | Iplan Guidance/Defaults | | | User Inputs | | | |
|---|---|---|---|---|---|---|---|
| Goal Time | | Partial | Market | | Partial | Market | |
| Horizon | Secure | Secure | Exposure | Secure | Secure | Exposure | Score |
| 5 to 10 Years | 0% | 20% | 80% | 100% | 0% | 0% | 0% |
| 5 to 10 Years | 0% | 20% | 80% | >80% | 0% | <20% | 30% |
| 5 to 10 Years | 0% | 20% | 80% | >80% | <10% | <20% | 25% |
| 5 to 10 Years | 0% | 20% | 80% | >80% | <20% | <10% | 20% |
| 5 to 10 Years | 0% | 20% | 80% | >80% | <20% | 0% | 10% |
| 5 to 10 Years | 0% | 20% | 80% | >60% | 0% | <40% | 50% |
| 5 to 10 Years | 0% | 20% | 80% | >60% | <10% | <40% | 40% |
| 5 to 10 Years | 0% | 20% | 80% | >60% | <20% | <30% | 35% |
| 5 to 10 Years | 0% | 20% | 80% | >60% | <30% | <20% | 30% |
| 5 to 10 Years | 0% | 20% | 80% | >60% | <40% | <10% | 25% |
| 5 to 10 Years | 0% | 20% | 80% | >60% | <40% | 0% | 20% |
| 5 to 10 Years | 0% | 20% | 80% | >40% | 0% | <60% | 70% |
| 5 to 10 Years | 0% | 20% | 80% | >40% | <10% | <60% | 60% |
| 5 to 10 Years | 0% | 20% | 80% | >40% | <20% | <50% | 55% |
| 5 to 10 Years | 0% | 20% | 80% | >40% | <30% | <40% | 50% |
| 5 to 10 Years | 0% | 20% | 80% | >40% | <40% | <30% | 45% |
| 5 to 10 Years | 0% | 20% | 80% | >40% | <50% | <20% | 40% |
| 5 to 10 Years | 0% | 20% | 80% | >40% | <60% | <10% | 35% |
| 5 to 10 Years | 0% | 20% | 80% | >40% | <60% | 0% | 30% |
| 5 to 10 Years | 0% | 20% | 80% | >20% | 0% | <80% | 90% |
| 5 to 10 Years | 0% | 20% | 80% | >20% | <10% | <80% | 85% |
| 5 to 10 Years | 0% | 20% | 80% | >20% | <20% | <70% | 75% |
| 5 to 10 Years | 0% | 20% | 80% | >20% | <30% | <60% | 70% |
| 5 to 10 Years | 0% | 20% | 80% | >20% | <40% | <50% | 65% |
| 5 to 10 Years | 0% | 20% | 80% | >20% | <50% | <40% | 60% |
| 5 to 10 Years | 0% | 20% | 80% | >20% | <60% | <30% | 55% |
| 5 to 10 Years | 0% | 20% | 80% | >20% | <70% | <20% | 50% |
| 5 to 10 Years | 0% | 20% | 80% | >20% | <80% | <10% | 45% |
| 5 to 10 Years | 0% | 20% | 80% | >20% | <80% | 0% | 40% |
| 5 to 10 Years | 0% | 20% | 80% | 0% | 0% | 100% | 90% |
| 5 to 10 Years | 0% | 20% | 80% | >0% | <10% | <100 | 95% |
| 5 to 10 Years | 0% | 20% | 80% | >0% | <20% | <90% | 100% |
| 5 to 10 Years | 0% | 20% | 80% | >0% | <30% | <80% | 95% |
| 5 to 10 Years | 0% | 20% | 80% | >0% | <40% | <70% | 85% |
| 5 to 10 Years | 0% | 20% | 80% | >0% | <50% | <60% | 80% |
| 5 to 10 Years | 0% | 20% | 80% | >0% | <60% | <50% | 75% |
| 5 to 10 Years | 0% | 20% | 80% | >0% | <70% | <40% | 70% |
| 5 to 10 Years | 0% | 20% | 80% | >0% | <80% | <30% | 65% |
| 5 to 10 Years | 0% | 20% | 80% | >0% | <90% | <20% | 60% |
| 5 to 10 Years | 0% | 20% | 80% | >0% | <100% | <10% | 55% |
| 5 to 10 Years | 0% | 20% | 80% | 0% | 100% | 0% | 50% |

Scoring Method Example: [The Percentage from the Goal Element Scoring Table (above)] multiplied by [the maximum goal element points] equals the goal element score.

The example method illustrated in FIG. 11 can be utilized as an example implementation for Goal Element Scoring System and Goal Element Illustration at 238 of FIG. 3, although portions or variations thereof can be utilized in accordance with other example embodiments of the invention.

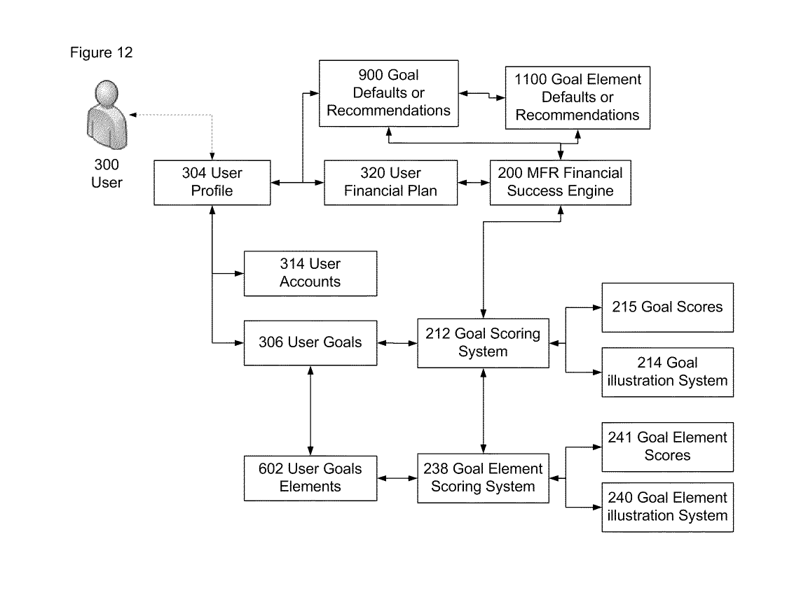

FIG. 12 is a chart of one example method for creating a goal score 212 and illustration 214 for each goal. Each goal can be scored. Each goal can also have a potential maximum score, for example 100 points.

An example method for determining a goal score is the sum of [Goal Priority score] plus {Goal Time Horizon Score] plus [Goal Savings Percentage Score] plus [Goal Target Need Score] plus [Investment Risk Allocation Score] plus [Financial Product Risk Score] plus [Asset Allocation Score] plus [Investment diversification Score] plus [Current Savings Score] plus [Liquidity Score]. Each goal can additionally be weighted based on the user's profile 304, the goal's weight/priority 210 and/or categorization 208. The score 212 can then be further calculated based on the goal weighting in order to determine the final score. This score can be presented to the user in the form of a score 215 and/or an illustration 214. The example method illustrated in FIG. 12 can be utilized as an example implementation for Goal Scoring System and Goal Illustration of FIG. 3, although portions or variations thereof can be utilized in accordance with other example embodiments of the invention.

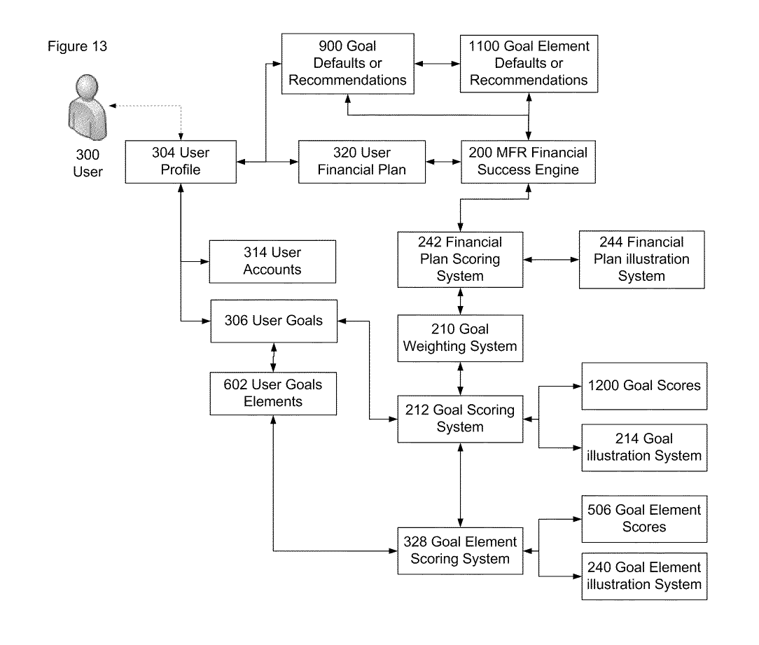

FIG. 13 is a chart of an example method for creating an overall plan score 242 and illustration 244. Each plan can have a potential maximum score, for example 100 points. The maximum allowable point total for the plan can be allocated across goals 306 based on the number of goals and the goal categorization 208. The allocation of points generates a percentage to be applied to each goal score 215. The goal scores can be aggregated to determine the overall plan score 244. An example can include:

TABLE O

| # of Goals | | | | |
|---|---|---|---|---|
| (Default + | | Scoring Weight by Default Goal Priority | | |
| Custom) | | Goal Priorities 1, 2, 3 | Goal Priorities 4, 5, 6 | Goal Priorities >6 |
| 7 | goals | 18.75% of each goal | 12.5% of each goal | 6.25% of each goal |
| 8 | goals | 17.65% of each goal | 11.65% of each goal | 6.05% of each goal |
| 9 | goals | 16.70% of each goal | 11.10% of each goal | 5.55% of each goal |
| >9 | goals | 16.00% of each goal | 10.50% of each goal | 20.5%/(total goals- |
| | | | | 6) of each goal |

This score can be presented to the user in the form of a score 244 and/or an illustration. The example method illustrated in FIG. 13 can be utilized as an example implementation for plan scoring system and plan illustration of FIG. 3, although portions or variations thereof can be utilized in accordance with other example embodiments of the invention.

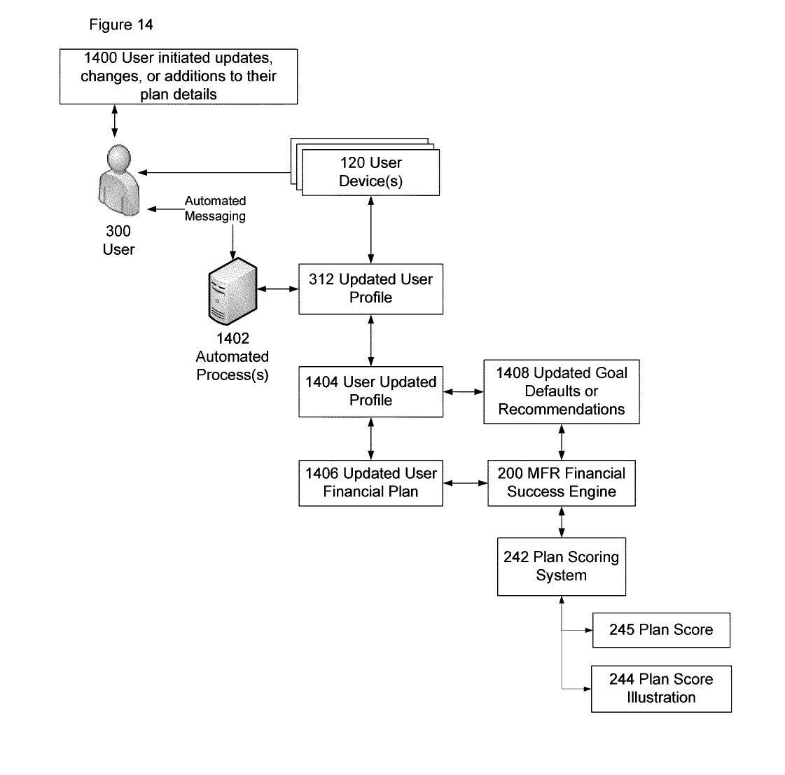

FIG. 14 is a chart of an example method for providing plan maintenance. The user 300 can return to the financial service platform or apparatus at any time to make changes, updates 1400 and/or addition to any of the goal 1408, account, or profile 1404 information or details. Based on user initiated actions or automated methods the goal elements scores, goal scores, and overall plan scores can be updated. Messaging to the user can be initiated through the financial service platform or apparatus or through automated methods to convey ways the user can improve the goal element scores, goal scores, and/or overall plan scores. Periodically the financial service platform or apparatus can run an automated process 1402 in order to update the user profile 312. The example method illustrated in FIG. 14 can be utilized as an example implementation for plan maintenance of FIG. 3, although portions or variations thereof can be utilized in accordance with other example embodiments of the invention.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams can not necessarily need to be performed in the order presented, or can not necessarily need to be performed at all, according to some embodiments of the invention.

These computer-executable program instructions can be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention can provide for a computer program product, comprising a computer usable medium having a computer readable program code or program instructions embodied therein, said computer readable program code adapted to be executed to implement one or more functions specified in the flow diagram block or blocks. The computer program instructions can also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for generating a financial plan score, comprising:
a financial plan engine operable within a service provider computing system, wherein the financial plan engine generates a financial plan score by interpreting information input by a user; and from at least one user device in network communication with the financial plan engine, wherein the user inputs information into the financial plan engine through the at least one user device; and
at least one third-party data source designated by the user, wherein the financial plan engine is in network communication with the at least one third-party data source, wherein the financial plan engine generates a financial plan score through evaluation of the information input by the user and information from the third-party data source.

2. The system of claim 1, wherein the financial plan engine comprises a weighting tool operable to generate weighted financial goals based on the user input information.

3. The system of claim 2, wherein the user input information comprises at least one of personal information, personal financial information, and financial goals information.

4. The system of claim 3, wherein the personal financial information is manually input by the user.

5. The system of claim 3, wherein the personal financial information is accessed directly from the third-party data source designated by the user.

6. The system of claim 3, wherein the financial goals information comprises at least one of goal categorization, goal weighting, and goal details.

7. The system of claim 6, wherein the user inputs the financial goals information by selecting from pre-determined prioritizing responses provided by the financial plan engine.

8. The system of claim 7, wherein the user selects answers selected from the pre-determined responses generate additional profiling questions to the user.

9. The system of claim 8, wherein the weighting tool assigns a pre-determined numerical value to each user financial goal information based on priority associated with pre-determined priority responses, and the sum of the goal numerical value represents a maximum amount attainable.

10. The system of claim 9, wherein the weighting tool compares the user financial goal numerical values to the responses and generates a user-specific score.

11. A method for generating a financial plan score, comprising:
receiving user information into a financial plan engine through a network communication, wherein the user information comprises at least one of personal information, personal financial information, and financial goals;
accessing at least one third-party data source via the network communication, wherein the third-party data source is accessed based on the user information;
generating a user profile comprising the user information and the accessed third-party data source information;
generating and prioritizing user goals based on used selections of pre-determined responses generated by the financial plan engine;
assigning a numerical value to each goal by comparing the user information with the prioritized status of the goals, wherein each numerical value is assigned to each goal based on its prioritized status, and the sum of the goal numericals value represents a maximum amount attainable; and
generating an overall score that represents a comparison of the financial goals and the user profile.

12. The method of claim 11, wherein the financial plan engine comprises a weighting tool operable to weight the goals based on the user information.

13. The method of claim 12, wherein the user information comprises at least one of personal information, personal financial information, and financial goals information.

14. The method of claim 13, wherein the financial goals information comprises at least one of goal categorization, goal weighting, and goal details.

15. A method for generating a financial score, comprising:
accessing a user profile, wherein the user profile comprises at least information including family status, user age, and financial status;
generating at least one recommendation based on the user profile;
prioritizing the financial goals, wherein the financial goals are prioritized by evaluating user-entered preferences comprising at least goal categorization and goal weight; and
scoring the financial goals with a numeric value up to a maximum value, wherein each score is calculated by comparing the difference between the at least one recommendation and the prioritized financial goals.

16. The method of claim 15, wherein the goal categorization preferences are entered by the user through pre-defined answers comprising at least core goals, primary goals, secondary goals, not applicable, or fully funded).

17. The method of claim 16, wherein user-defined goal preferences are entered by the user through pre-determined answers defining the comparative value of each goal categorization preference.

18. The method of claim 17, wherein the financial goal user-entered preferences further comprise goal details/elements comprising at least goal target, savings percentage, goal time horizon, and risk allocation.

19. The method of claim 18, wherein the financial goal score comprises individual scores for an overall financial score, a score for an individual goal, and a score for an individual goal detail/element.
